(19) United States
(12) Patent Application Publication
(10) Pub. No.: US 2018/0053265 A1
(43) Pub. Date: Feb. 22, 2018

(54) Method and System for Engaging and Coordinating Real Estate Transactions from Contact to Contract

(71) Applicant: Benjamin Wade Lyon, Williamsburg, VA (US)

(72) Inventor: Benjamin Wade Lyon, Williamsburg, VA (US)

(21) Appl. No.: 15/242,463

(22) Filed: Aug. 19, 2016

(51) Int. Cl. G06Q 50/16; G06Q 40/02; G06F 17/30

(52) U.S. Cl. CPC G06Q 50/16; G06Q 50/167; G06F 17/30867; G06Q 40/025

(57) ABSTRACT

A Method and System for Engaging and Coordinating Real Estate Transactions from Contact to Contract is disclosed. This Method and System serves both For Sale and For Rent transactions in Real Estate by offering simple to use Offer, Negotiation, Agreement, Data Collection, Stored Data Integration, Document Preparation, Variability Controls (Logical IF arguments which add or remove documents based on document and date triggers), Co-Signer Setup, and Secure and Efficient E-Signature Processes to automate and remove complexity from real estate transactions.

### CROSS REFERENCES TO RELATED APPLICATIONS

This application claims the benefit of Applicants' prior provisional application, No. 62/317,605, filed on Apr. 3, 2016.

### FEDERALLY SPONSORED RESEARCH AND DEVELOPMENT

Not Applicable

### JOINT RESEARCH AGREEMENT

Not Applicable

### FIELD OF INVENTION

The technology relates generally to a method and system which manages the home buying/selling and renting/leasing processes to negotiate, prepare and effect legal contracts and disclosures. It includes a system and method for data collection, preparation, delivery and storage of relevant documentation, and the data contained therein.

### BACKGROUND

The real estate industry has been stable with relative growth for decades. Innovation has led to better methods of marketing, engaging, negotiating, and drafting the many contracts and disclosures needed to executed and ratify real estate contracts. The focal point of the innovation has been heavily placed on brokerages and simplifying their processes in an effort to tap into the larger market segmentation. As a result of the innovation over the last 30 years, brokerages and professionals are able to utilize the regional MLS (Multiple Listing Services) data integrated with various document drafting tools such as ZipLogix which allows real estate professionals to populate pre-defined forms, mark-up key contract elements, and add e-signature blocks using integrated TouchSign technology (In the case of ZipLogix, which allows the user to create signers to the contracts (by the real estate professional) and create signature fields. The users will then receive an email and create their signing accounts, and sign the documents. All this technology is aimed at professionals and would not be effectively utilized by non-professionals as the contracts still must be filled, setup, and managed by the selling agent.

While the home buying/selling and renting/leasing processes are primarily controlled by real estate professionals, those who are paying the commissions (Home Owners) may no longer want or need the third party intervention. However, the home buying/selling and renting/leasing processes require a great deal of negotiation, data collection, preparation, variables, signatures and executed agreements and disclosures. Most homeowners simply do not have the necessary knowledge and information to effectively complete this process on their own.

This Method and System IS NOT developed for professionals. Instead, it solves the needs of the average homeowner. The tax industry has seen similar development over the last 20 years, which has empowered the average individual from relying on tax professionals to doing their own taxes through the support of automated systems and methods which guide and support users in completing their necessary tax forms.

This Method and System is synonymous (in a way) to that of the tax industry. The Method and System for Engaging and Coordinating Real Estate Transactions from Contact to Contract serves both For Sale and For Rent transactions by offering simple to use Negotiation, Agreement, Data Collections, Stored Data Integration, Document Preparation, Variability Controls (Programmed IF Statements which add or remove documents based on document and date triggers), Co-Signer Setup, and Secure and Efficient E-Signature Processes.

By creating a method and system to remove the complexity and knowledge level required to effectively use the system, we are providing the average individual with options to control their own property transactions, without the necessary support of real estate agents and the high fees associated with their support.

### SUMMARY

The Method and System for Engaging and Coordinating By Owner Real Estate Transactions from Contact to Contract serves both For Sale and For Rent transactions by offering simple to use Negotiation, Agreement, Data Collections, Stored Data Integration, Document Preparation, Variability Controls (Programmed IF Statements which add or remove documents based on document and date triggers), Co-Signer Setup, and Secure and Efficient E-Signature Processes.

It begins with a unique and secure user registration and login. Each user must create an account using a valid email address. They also create their E-Signature during sign-up. This is an important step to ensure proper authorization, security and control in each transaction. The registered user account is also used for education, networking, social integration, and tracking purposes.

Next, the logged in user may list their own property (Acting as Seller—For Sale OR Landlord—For Rent), or search to purchase/lease a property (Buyer—For Sale OR Tenant—For Rent). In the case of a new listing, the Seller/Landlord will enter key details about the property which is stored in our background database tables. This information is drawn on to properly reflect back this information in display, but it is also integral to the document preparation and variability conditions. For example, if the home is built prior to 1978, then a Lead-Based paint form is required, later in the task-flow, the system and method will auto-trigger the need for this form and populate the existing data for the users. There are tools available to the users to make the search, viewing, communication, and other necessities of the home buying/renting process simple, which are designed to make the process even simpler than the current methods of using multiple third parties to administer these needs. As these will not be considered for patent protection, we will not list these features.

In continuation, when a buyer/tenant locates a property meeting their interest, they have an option on the view listing page to “Make and Offer” on the property. This function allows the user to make a tentative offer on the property, which will be sent and received electronically from the initiating buyer/tenant to the seller/landlord. This tentative offer may include the price, contingencies, user details, qualifications, and comments. In response, the seller/landlord may choose to Reject the Offer, Counter the Offer, or Accept. If rejected, the offer is closed. If countered, the Buyer/Tenant now has the same options and may negotiate accordingly. If accepted, the users are presented with an option of using our Method and System further with the Contract Tools, or they may use pre-defined templates to complete their sell/rent transaction.

The Contract Tools continue the task-flows by collecting a few pivotal questions from the seller/landlord with the Seller Questionnaire. We collected data on the requirements and details for Earnest Money Deposits, Items to Convey, Real Estate Agent Affiliation, Post-Closing Occupancy, Availability, Requirements and if any Co-Signers will be added to the contracts and e-signatures. These details trigger documents, and optimize the work-flows of the management system. Some forms will be necessary and added to the work-flows, and others will be removed based on the data.

After this data is entered, the Seller/Landlord is presented with the draft forms for their review. Upon review, the users will submit the forms as reviewed. This submission triggers an email to the Buyer/Tenant, who will now proceed with answering a few pivotal questions of their own in the Buyer Questionnaire and add any Co-Signers on the Buyer/Tenant side. The buyer/Tenant will answer the questions presented, which will trigger documents and optimize the work-flows of the management system further.

When the questions have been addressed and any co-signers added, the buyer/tenant will review the automatically prepared documents, based on the optimized work-flows (document triggers and variable controls). Upon the user's review, the user will submit their review and a summary of key terms form is displayed for the user's final review, highlighting critical information in a summarized window. If they agree, they must mark their agreement. After submitting their agreement, they are led through the secure e-signature process on the site via the optimize work-flow manager. Any Buyer/Tenant co-signers repeat the process until all buyers have completed their signing process.

After all the Buyer(s)/Tenant(s) have completed their e-signature process, the Seller(s)/Landlord(s) are contacted by the management work-flows to complete their e-signature processes. They are displayed the same summary of key terms and must mark their agreement to continue to signing. Each Seller/Landlord will complete the signing through their unique login and once all the signatures have been applied by all the Seller(s)/Landlord(s), the documents are executed and ready to be purchased by the seller/landlord and downloaded to PDF.

The system stores the documents in the registered user's account under “My Documents”. Once purchased, the executed contracts and disclosures are able to be downloaded and printed at any time.

### BRIEF DESCRIPTION OF THE DRAWINGS

Various embodiments of the invention are disclosed in the following detailed description and accompanying drawings.

FIG. 1 illustrates the choices for user login/registration.

FIG. 2 illustrates the menu options under user Sign-Up

FIG. 3 illustrates the first steps in user registration.

FIG. 4 illustrates the continuation steps in user registration.

FIG. 5 illustrates the final steps in user registration.

FIG. 6 illustrates the first steps in user login.

FIG. 7 illustrates the continuation steps in user login.

FIG. 8 illustrates the final steps in user login.

FIG. 9 illustrates work-flows for the property search.

FIG. 10 illustrates work-flows for the property search.

FIG. 11 illustrates work-flows for the property search.

FIG. 12 illustrates work-flows for the property search.

FIG. 13 illustrates work-flows for the property search.

FIG. 14 illustrates the work-flows on displaying properties to users.

FIG. 15 illustrates the optional feature of scheduling a viewing appointment.

FIG. 16 illustrates the optional feature of contacting the owner electronically.

FIG. 17 illustrates the optional google maps directions integration.

FIG. 18 illustrates the optional feature of saving the property as a favorite.

FIG. 19 illustrates the Make an Offer (For Sale Properties) first Step.

FIG. 20 illustrates the first work-flow question in the offer table—Closing Assistance (For Sale Properties).

FIG. 21 illustrates the next work-flow question in the offer table—Contingencies (For Sale Properties).

FIG. 22 illustrates the options regarding financing qualifications (For Sale Properties).

FIG. 23 illustrates the required agreement regarding the offer is tentative and non-binding and submission of the offer.

FIG. 24 illustrates the receipt of the offer by the seller and the negotiation options.

FIG. 25 illustrates the receipt of the counter-offer and the continued negotiation options.

FIG. 26 illustrates the Make an Offer (For Rent Properties) work-flows.

FIG. 26 (b) illustrates the Make an Offer (For Rent Properties) Lease Term Options.

FIG. 27 illustrates the Make an Offer (For Rent Properties) Pet Application Options.

FIG. 28 illustrates the receipt of the offer by the landlord and the negotiation options.

FIG. 29 illustrates the option of the Seller/Landlord to use the Contract (Preparation) Tools.

FIG. 30 illustrates the first question presented in the seller questionnaire and the work-flows (For Sale Properties)—Earnest Money Deposit.

FIG. 31 illustrates the second question presented in the seller questionnaire and the work-flows (For Sale Properties)—Items to Convey.

FIG. 32 illustrates the third question presented in the seller questionnaire and the work-flows (For Sale Properties)—Real Estate Agent Affiliation.

FIG. 33 illustrates the fourth question presented in the seller questionnaire and the work-flows (For Sale Properties)—Post-Closing Occupancy.

FIG. 34 illustrates the work-flows and questions for adding a Co-Signer.

FIG. 35 illustrates the system archiving and registration process for Co-Signer auto account review and creation.

FIG. 36 illustrates the Post-Closing Occupancy work-flow and variable selectors.

FIG. 37 illustrates the variable system trigger work-flow for the Lead-Based Paint Agreement.

FIG. 38 illustrates the first question in Post-Closing Occupancy Questionnaire work-flow.

FIG. 39 illustrates the second question in Post-Closing Occupancy Questionnaire work-flow.

FIG. 40 illustrates the third question in Post-Closing Occupancy Questionnaire work-flow.

FIG. 41 illustrates the fourth question in Post-Closing Occupancy Questionnaire work-flow.

FIG. 42 illustrates the fifth question in Post-Closing Occupancy Questionnaire work-flow.

FIG. 43 illustrates the sixth question in Post-Closing Occupancy Questionnaire work-flow.

FIG. 44 illustrates the seventh question in Post-Closing Occupancy Questionnaire work-flow.

FIG. 45 illustrates the seller(s)/Landlord(s) work-flow steps in the Lead-Based Paint Disclosure form.

FIG. 46 illustrates the seller(s)/Landlord(s) work-flow steps in the Property Condition Disclosure form.

FIG. 47 illustrates the seller(s)/Landlord(s) work-flow steps in the draft Purchase and Sale Agreement form.

FIG. 48 illustrates the completion of the Seller/Landlord preparation work-flow and shift to Buyer/Tenant.

FIG. 49 illustrates a question in the Buyer Questionnaire (For Sale Properties)—VA/FHA Loan.

FIG. 50 illustrates a question in the Buyer Questionnaire (For Sale Properties)—Closing Date.

FIG. 51 illustrates a question in the Buyer Questionnaire (For Sale Properties)—Offer Expiry.

FIG. 52 illustrates the display of the summary of key terms and work-flow.

FIG. 53 illustrates the Buyer(s)/Tenant(s) work-flow steps in the Lead-Based Paint Disclosure form.

FIG. 54 illustrates the Buyer(s) review of the Post-Closing Occupancy Agreement Form.

FIG. 55 illustrates the first question in the Landlord Questionnaire regarding the security deposit requirement (For Rent Properties).

FIG. 56 illustrates the next question in the Landlord Questionnaire (For Rent Properties)—Pet Allowance and Pet Deposit.

FIG. 57 illustrates the next question in the Landlord Questionnaire (For Rent Properties)—Lease Effective Date.

FIG. 58 illustrates the next question in the Landlord Questionnaire (For Rent Properties)—Provided Furnishings.

FIG. 59 illustrates the next question in the Landlord Questionnaire (For Rent Properties)—Utilities Included.

FIG. 60 illustrates the Seller(s)/Landlord(s) preparation of the Property Condition Disclaimer form for submission/review.

FIG. 61 illustrates the Buyer(s)/Tenant(s) review of the Draft Lease Agreement form for Review.

FIG. 62 illustrates the options for Tenant(s) to add a Co-Signer.

FIG. 63 illustrates the login work-flows for users in preparation for signing.

FIG. 64 illustrates the display of the summary of key terms for review.

FIG. 65 illustrates the display of the summary of key terms for signing.

FIG. 66 illustrates the work-flows for the e-signature capturing of signatures for the advisory to buyers and sellers form.

FIG. 67 illustrates the work-flows for the e-signature capturing of signatures for the property condition disclaimer form.

FIG. 68 illustrates the work-flows for the e-signature capturing of signatures for the lead-based paint form.

FIG. 69 illustrates the work-flows for the e-signature capturing of signatures for the VA/FHA Addendum form.

FIG. 70 illustrates the work-flows for the e-signature capturing of signatures for the post-closing occupancy form.

FIG. 71 illustrates the work-flows for the e-signature capturing of signatures for the Purchase and Sale Agreement form.

FIG. 72 illustrates the work-flows for the download and conversion to PDF to retrieve executed documents (For Sale Properties).

FIG. 73 illustrates the login work-flows for users in preparation for signing.

FIG. 74 illustrates the work-flows for the e-signature capturing of signatures for the lead-based paint form.

FIG. 75 illustrates the work-flows for the e-signature capturing of signatures for the Property Condition Disclaimer form.

FIG. 76 illustrates the work-flows for the e-signature capturing of signatures for the Lease Agreement form.

FIG. 77 illustrates the work-flows for the download and conversion to PDF to retrieve executed documents (For Rent Properties).

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims. Such other embodiments may be readily devised by those skilled in the art without departing from the spirit or scope of this invention and it is our intent they be deemed within the scope of our invention.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### INDEX

### 100—Registration/Login/Signature Creation

110—Signup
120—Registration
130—Login

### 200—Property Search

210—Properties for Sale
   2101—Search Filters
   2102—Property Search
   2103—View Property
   2104—Schedule a Viewing
   2105—Contact Listing User
   2106—Get Directions
   2107—Add to Favorites
220—Properties for Rent

### 300—Make and Offer

310—For Sale
   3101—Contingencies
   3102—Loan Status
   3103—Agreement Check
   3104—Offer Receipt
   3105—Negotiation
320—For Rent
   3201—Lease Term
   3202—Date of Occupancy
   3203—Pets
   3204—Agreement Check
   3205—Offer Receipt
   3206—Negotiation

### 400—Contract Solutions—For Sale (Seller)

410—Seller Questionnaire
   4101—Earnest Money
   4102—Items to Convey
   4103—Real Estate Agency
   4104—Post-Occupancy
   4105—Ownership Interest/Co-Signers
420—Lease or Post-Closing Agreement
   4201—“Year Built” System Check
430—Post-Closing Occupancy Agreement
   4301—Mortgage Payment
   4302—Delay Penalty
   4303—Security Deposit
   4304—Retention of Receipts
   4305—Utilities
   4306—Rental Insurance
   4307—Liability Insurance
440—Post—Closing Review
450—Lead-Based Paint Disclosure
   4501—Seller's or Lessor's Disclosure
460—Property Condition Disclosure
470—Purchase and Sale Agreement (Draft)

### 500—Contract Solutions—For Sale (Buyer)

510—Buyer Questionnaire
   5101—VA/FHA Loan
   5102—Closing Date
   5103—Offer Expiration
520—Ownership Interest/Co-Owners
530—Summary of Terms
540—Advisory to Buyers and Sellers
550—Property Condition Disclaimer
560—Lead Based Paint Form
   5601—Purchaser's/Lessee's Initial
   5602—EPA Pamphlet
   5603—Due Diligence Period
570—VA/FHA Loan Addendum
580—Post Closing Occupancy Review
590—Purchase and Sale Agreement Review
   5901—Completion of Preparation

### 600—Contract Solutions—For Rent (Landlord)

610—Questions for Landlord
   6101—Security Deposit
   6102—Pets Welcome?
   6103—Effective Date of Lease
   6104—Furnishings
   6105—Utilities/Services Included
   6106—Co-Signer Requirement
620—Ownership Interest/Co-Owners
630—Lead Based Paint Form
   6301—Landlord's Disclosure
640—Property Condition Disclaimer
650—Lease Agreement (Draft)

### 700—Contract Solutions—For Rent (Tenant)

710—Notice to Tenant
720—Other Tenants/Roommates
730—Summary of Terms
740—Lead Based Paint Hazards
   7401—Purchaser's/Lessee's Initial
   7402—EPA Pamphlet
   7403—Due Diligence Period
750—Property Condition Disclosure
760—Lease Agreement
770—Completion of Preparation

### 800—Sign Documents (Sale)

810—Summary of Terms
820—Advisory to Buyers and Sellers
830—Property Condition Disclaimer
840—Lead-Based Paint Hazards
850—VA-FHA Loan Addendum
860—Post Closing Occupancy Agreement
870—Purchase and Sale Agreement
880—Seller(s) Signatures

### 900—Purchase Documents (Sale)

### 1000—Sign Documents (Rent)

1010—Summary of Terms
1020—Lead Based Paint Hazards
1030—Property Condition Disclosure
1040—Lease Agreement
1050—Landlord(s) Signatures

### 1100—Purchase Documents (Rent)

### DETAILED DESCRIPTION

100 Registration/Login/Signature Creation:

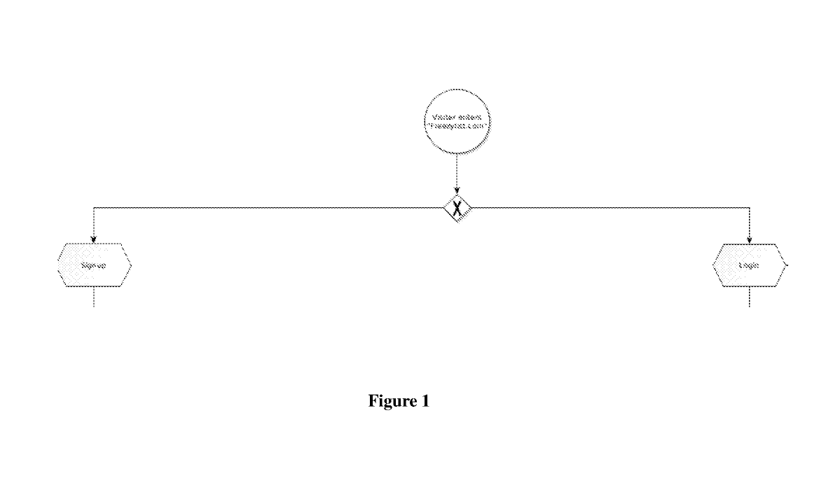

With the reference to the embodiment illustrated in FIG. 1 as there are two ways to access all the features of the website, first is “Login” if already registered and second way is to register with Freezylist.com, then proceed logging in.

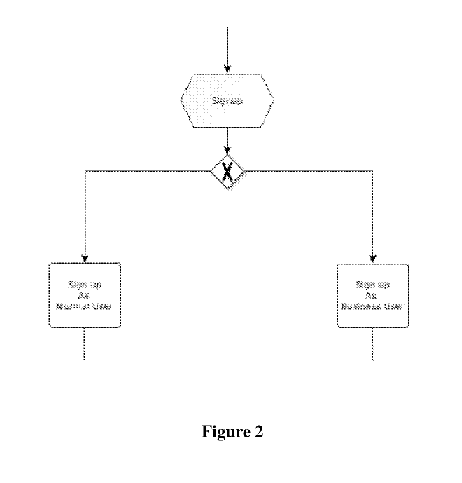

110 Signup: As shown in FIG. 2 there are two types of user accounts: “Normal User” or “Business User”.

Normal user can buy/sale properties, however, business users are limited accounts. Only Normal Users can use these Contract Tools (as diagramed for patent protection).

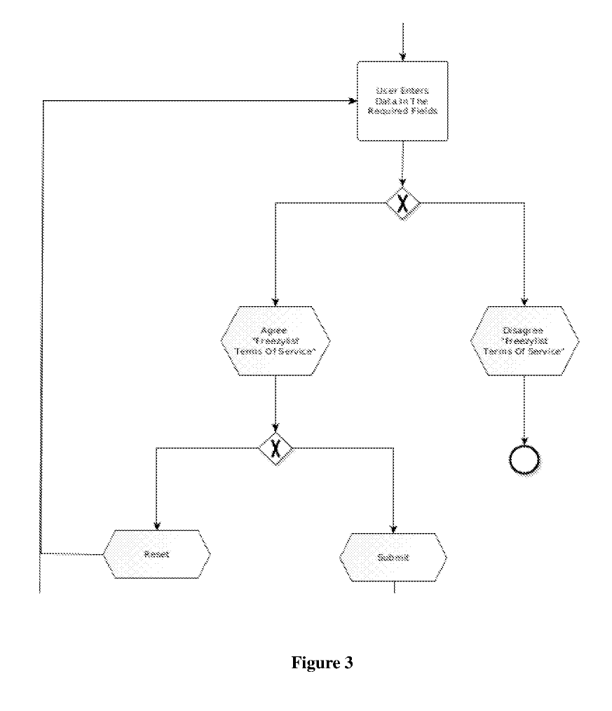

120 Registration: As shown in FIG. 3 for registration user has to enter the data into required fields and enter full names, which will be used in Official Contracts and to generate an electronic signature.

After, there are terms & condition which must be agreed to continue. If the user agrees with the terms & condition then an activation email is sent to the email address used to register.

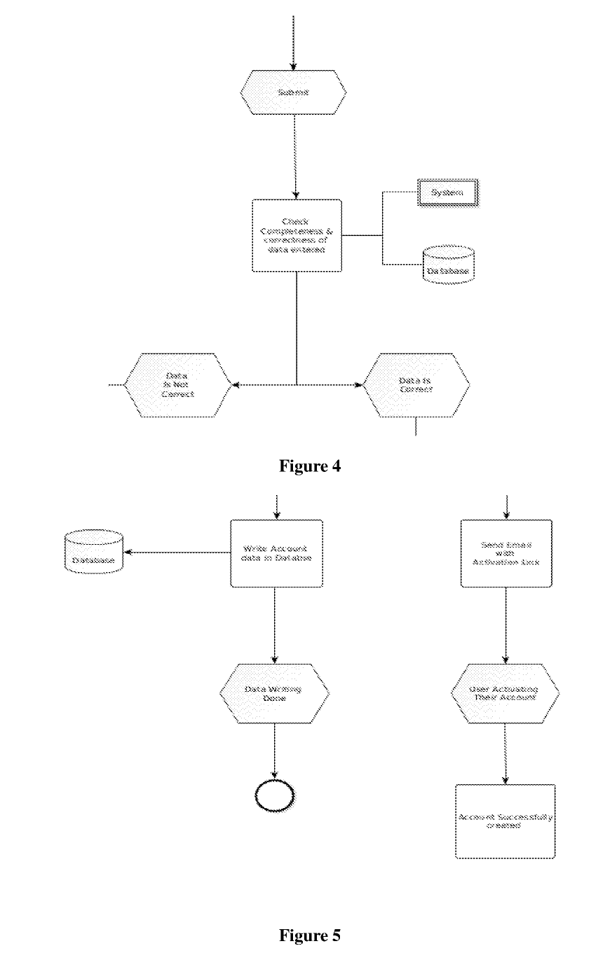

The completeness and correctness of the information entered by user are checked by the system as shown in FIG. 4. The user account cannot be created with partial information.

As shown in FIG. 5, the user will receive an activation link via email. User can activate his account using this link.

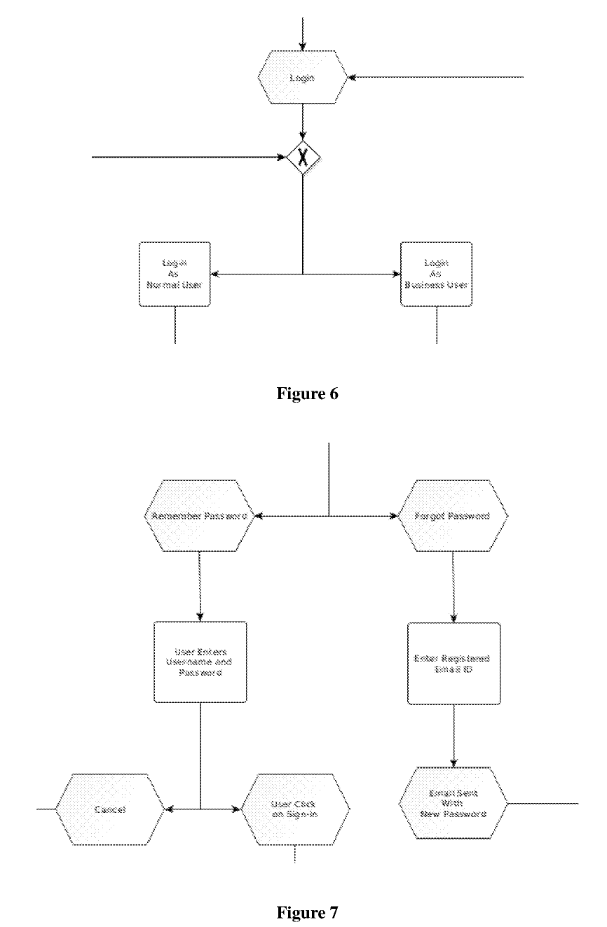

130 Login: As shown in FIG. 6 there are two types of users: ‘Normal User’ and ‘Business User’.

For login, the user should remember the correct username and password. In case a user cannot recall their password/username then he can retrieve password by clicking the “Forgot Password” link as shown in FIG. 7. User will enter their registered email/username and a password reset link will be sent to their email address on file. After receiving their new password, the user can login to the website. Logical access requires a correct username and password.

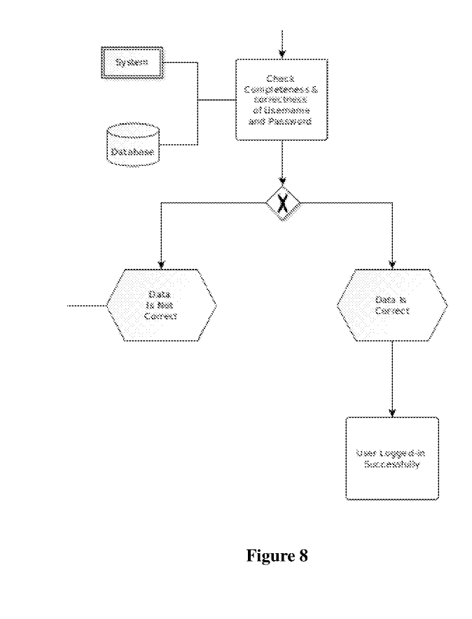

The system checks the completeness and correctness of the information entered by user for login, if it is correct then user will successfully log in as in FIG. 8.

200 Property Search:

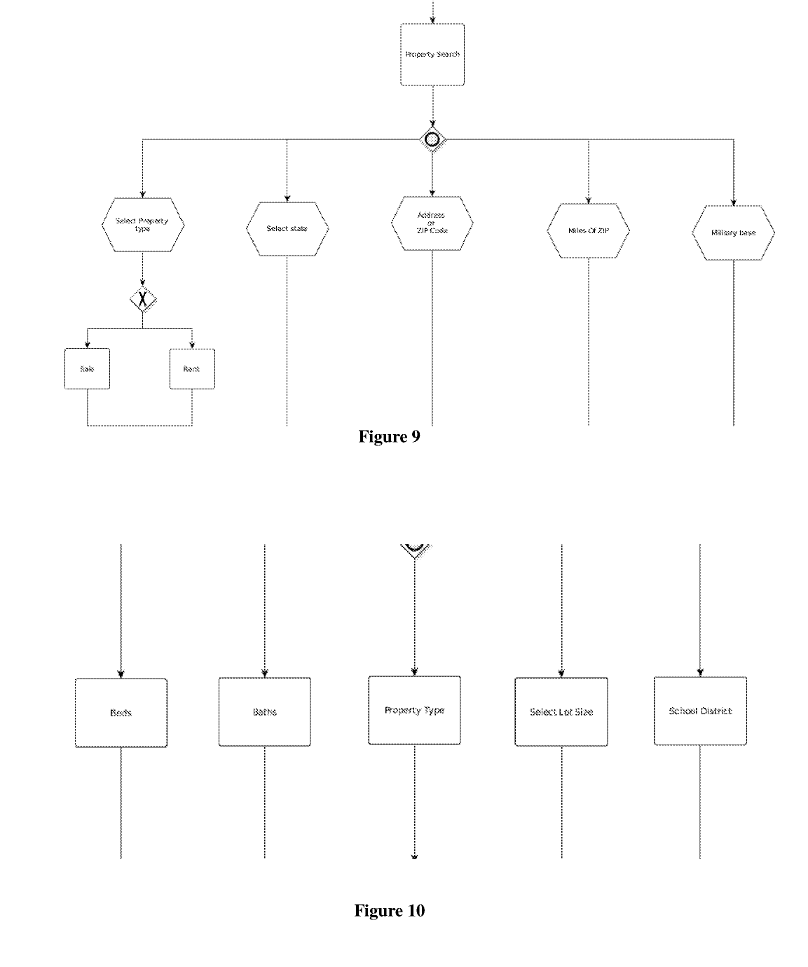

Users can search properties without being registered; however, the contract tools are only available to registered users. These properties have been listed and the data populated by our Registered Members (Either by Sellers—For Sale OR Landlords—For Rent). Upon clicking the Property Search button the following options appear, as shown in FIG. 9. Upon clicking the Search Button the system will search property from the database as in FIG. 12.

210 Properties for Sale: Select “Sale” from property type button available for user. There are many filters provided to make property search simple. The user can search properties according to states, address, zip code, miles of zip, and by the surrounding areas of Military Bases, and others as illustrated in FIG. 9.

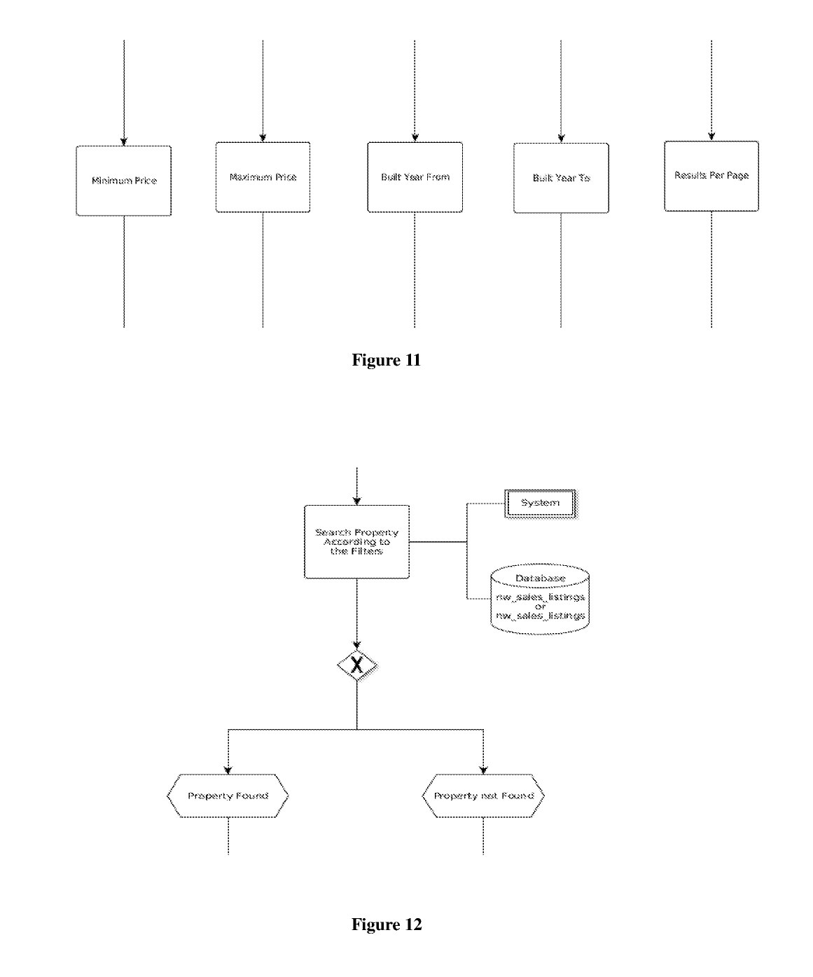

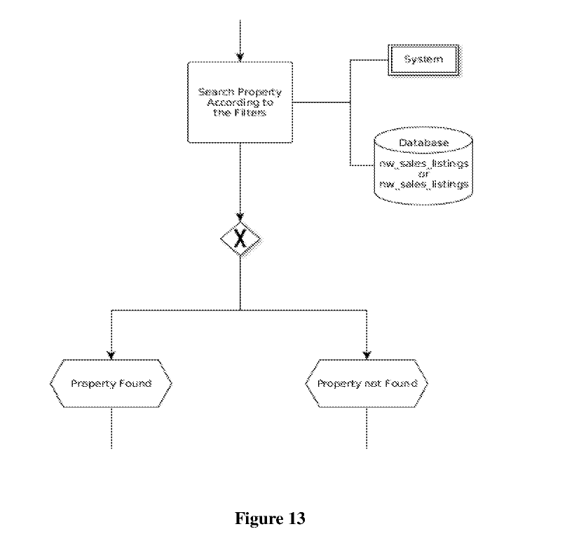

2101 Search Filters: There are more filters to search desired properties very easily as shown in FIG. 10 and FIG. 11. Users can search properties according to the beds and baths, lot sizes, school districts, build year, and according to the minimum and maximum price of the properties, as shown in FIG. 11.

2102 Property Searching: After clicking the search button, our platform displays the properties in two ways. First is a simple list view and the second option is displayed with Map features as in FIG. 12. The map will display the location of the properties searched via clickable map icons.

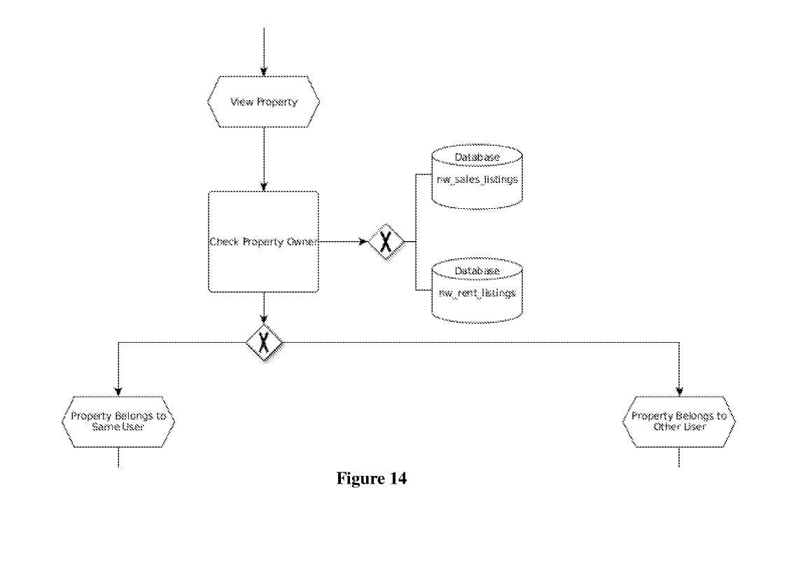

2103 View Property: As the user clicks on the ‘View Property’ button, the details of the selected property are then displayed, as the system checks whether the property is listed by the logged in user, or otherwise (FIG. 14).

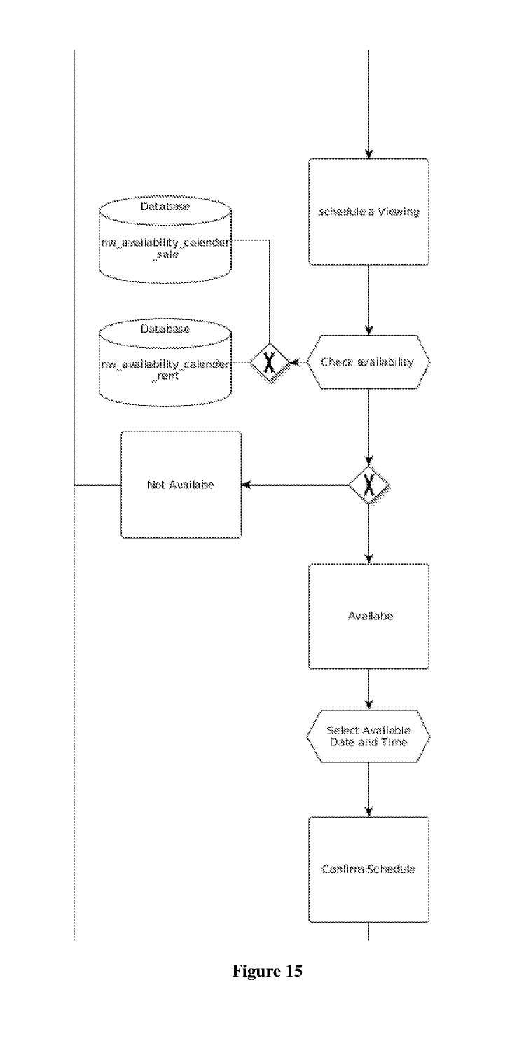

2104 Schedule a Viewing: Users can schedule a viewing time with the listing owner. The database query will return the availability of the property owner and the user will select their desired date and time from the availability calendar (administrated by the listing user). As the user schedules the viewing, a confirmation message and email will be sent to the property owner regarding the scheduling (FIG. 15).

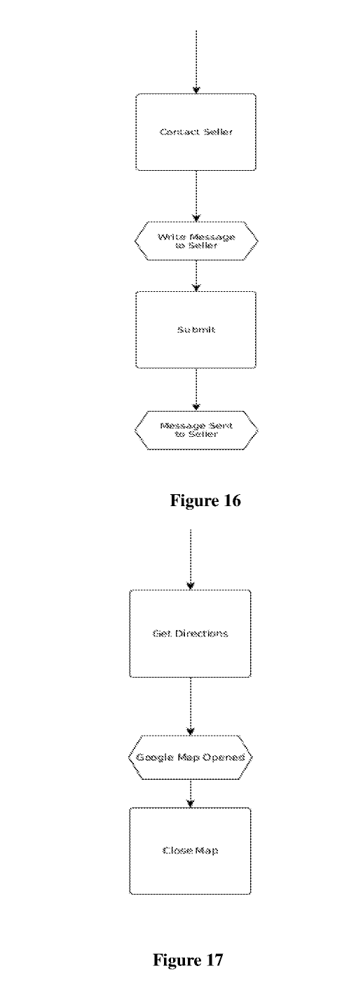

2105 Contact Listing User: Users may contact the Listing owner directly by sending a personal message by clicking “Contact seller” as in FIG. 16.

2106 Get Directions: Maps is provided to find the location of the property very easily. The user may click “Get Directions” and a map will be displayed, with the location of the property. (FIG. 17).

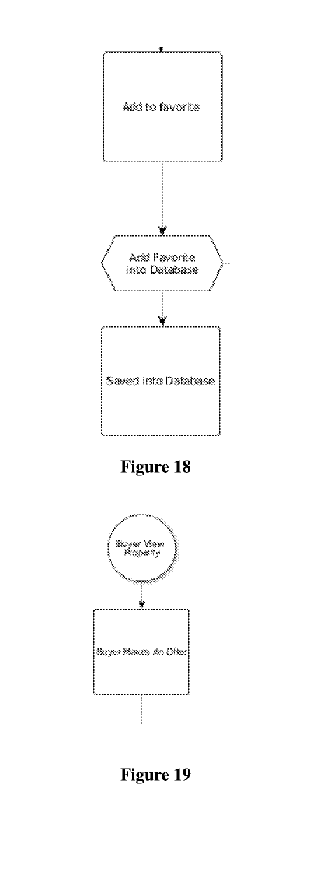

2107 Add to Favorites: User can add the property to his favorites by clicking “Add to Favorites”. The property will show in to the favorites of the user account (FIG. 18).

220 Properties for Rent: Select “Rent” from property type button available for user. The search criteria for the Rent properties is very similar to that of sale listings (See topics 2101-2107). There are filter variations provided to customize the users search further as shown in FIG. 9.

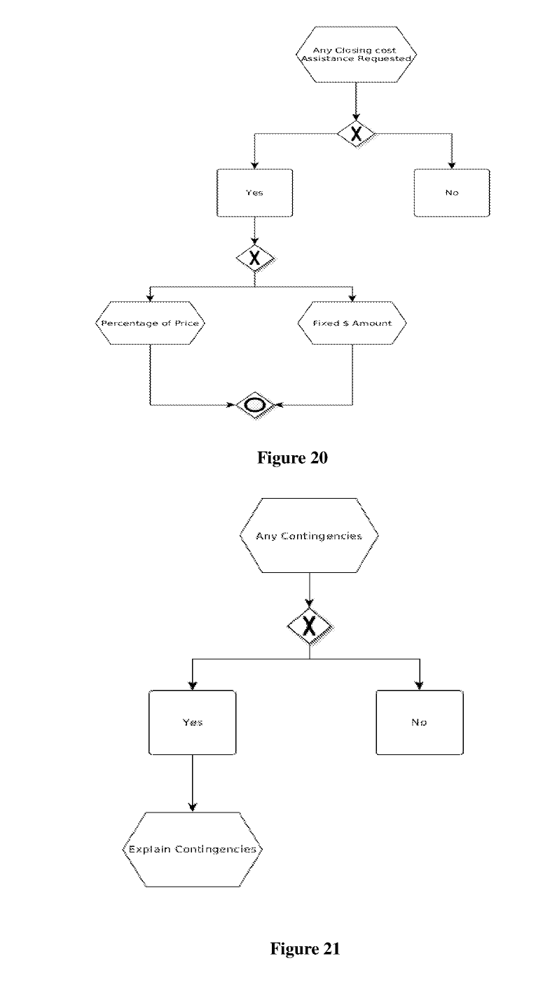

300 Make an Offer: After searching and viewing the property, if user is interested in purchasing the property, the user can “Make an Offer” to the property owner from the listing details page (FIG. 19). The offer is a tentative offer to begin having a conversation, but the offer details are captured in the database. Only one active offer per property may be submitted by the purchasing user.

310 For Sale: To make an offer on a property, the purchasing/leasing user must answer a few questions (See FIG. 20). 1) What is the tentative offer price? Any cost closing assistance? If yes, what is the amount requested in either % of Price (Usually <1%) or Fixed $ amount (Usually <1% of Selling price) as shown in FIG. 20. Closing Cost Assistance may be requested by Buyers to offset the administrative fees at Closing (Upon Ownership Transfer).

3101 Does the user require contingencies? If yes, the purchasing user must provide the terms (FIG. 21). Contingencies are special contract requirements which need to be met in order for transaction to be completed.

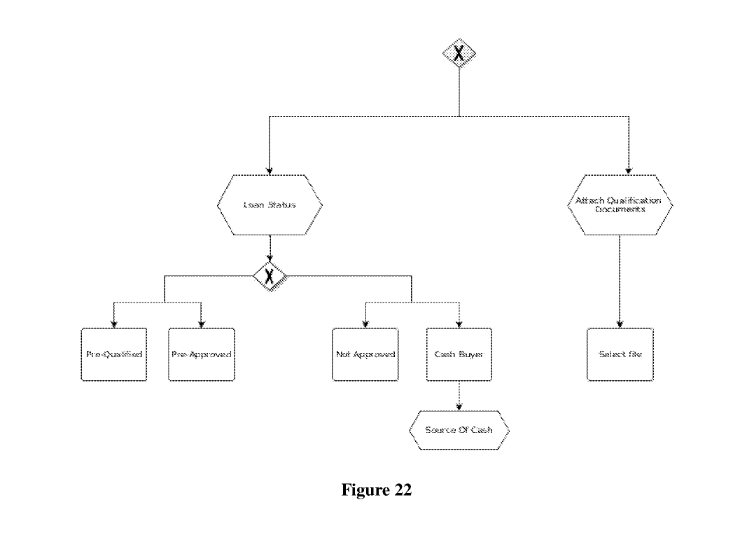

3102 In make an offer process buyer must confirm his loan status either it is Pre-approved (Income and credit is verified by a lending institution), Pre-Qualified (Submitted verbal information to a loan officer, but income and credit is not verified) or is not approved or a cash buyer. If the buyer want to deal with cash, the buyer may enter the source of cash. Further, the buyer should attach their loan pre-approval document received from their lending institution (if applicable) as shown in FIG. 22.

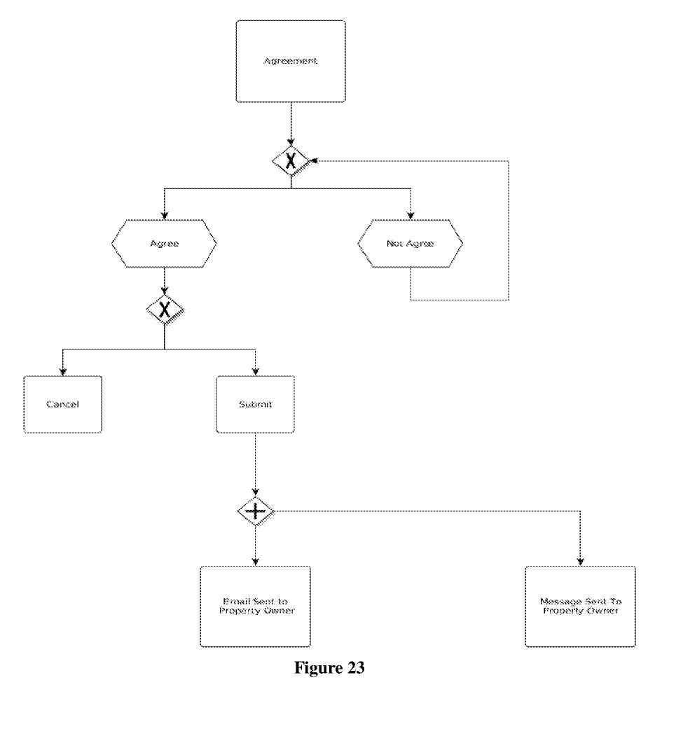

3103 The user must agree to our disclaimer clause to continue, noting that “the tentative offer is non-binding and unenforceable. This offer serves to engage a potential buyer and seller in preparation for entering into an agreement, and does not constitute an official offer. Buyer will have the option to enter into an official contract using our Contract Tools upon agreement of terms”. As in FIG. 23, if the buyer agrees with the disclaimer, the offer will be sent to the seller. If no agreement, the offer cannot be submitted. After submission, an email and site message will sent to the seller regarding the offer.

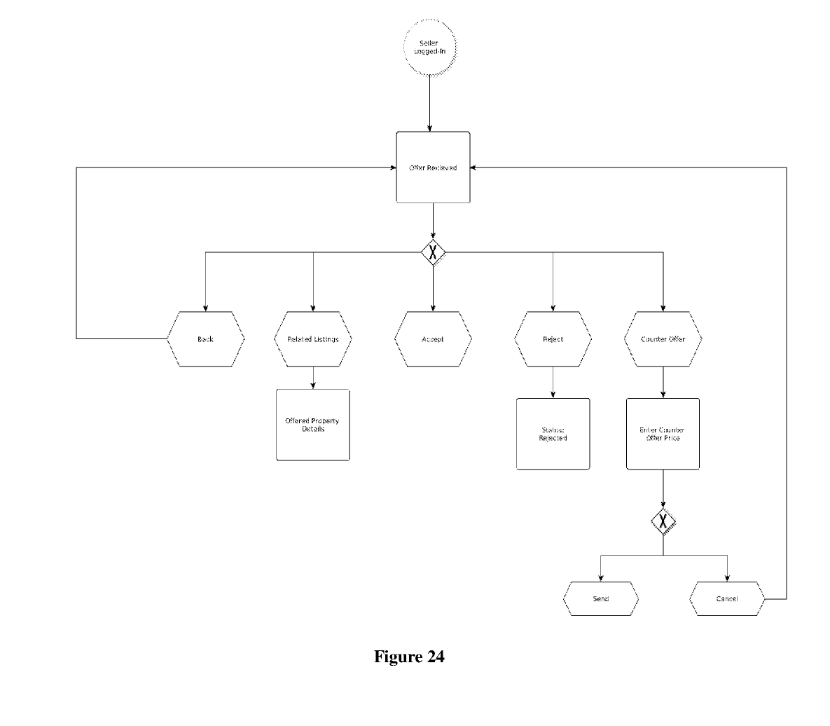

3104: After the purchaser makes their offer, the seller will receive the offer and will need to take action to proceed. There are three possibilities as shown in FIG. 24. The seller may accept the offer submitted, counter-offer the price, or reject the offer. If rejected, the purchasing the user may resubmit a new offer.

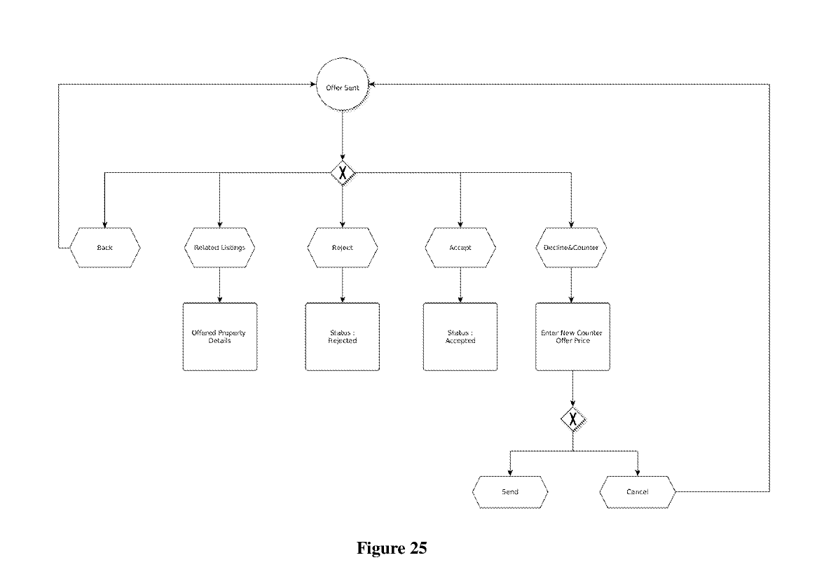

3105: If the seller counters the offer, the buyer will receive a counter offer message and email. The buyer will not have the same options as the seller had prior, as shown in FIG. 25. The purchasing user may accept the offer submitted, counter-offer the price, or reject the offer. If rejected, the purchasing the user may resubmit a new offer. The negotiation may go back and forth between users as many times as necessary, and the options remain the same.

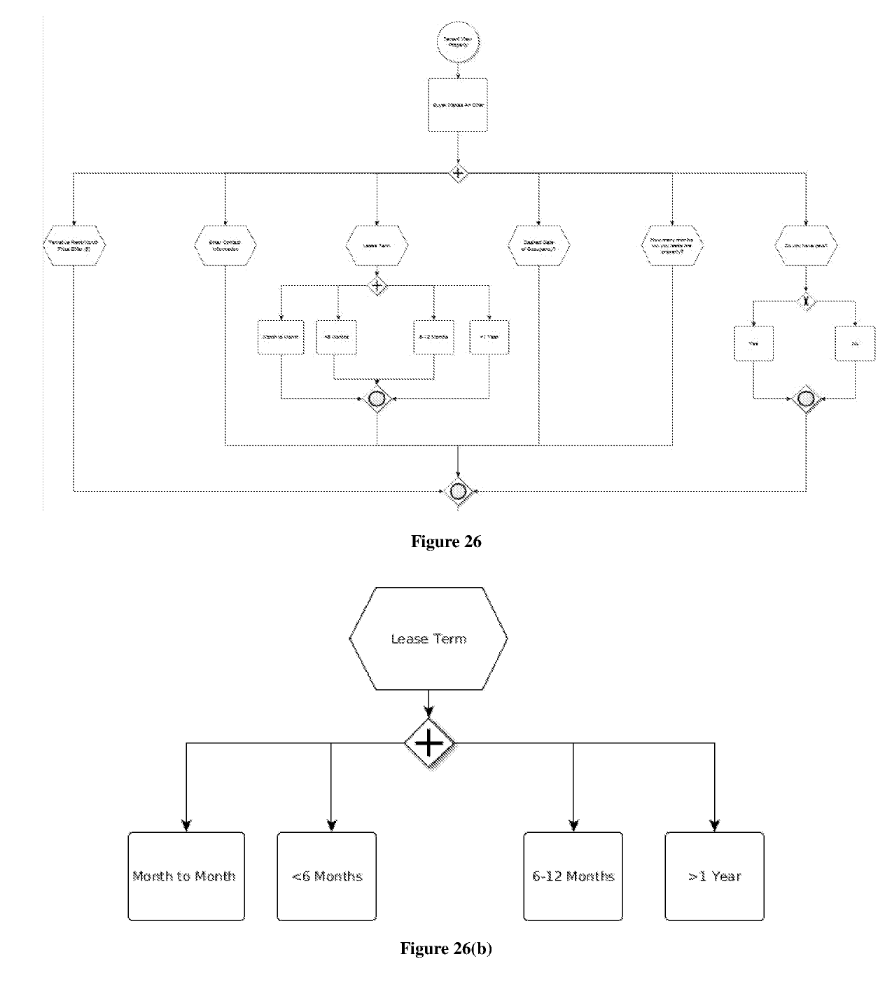

320 For Rent: To make an offer on a property, the leasing user must provide some information. First is the Tentative Rent/Month Price Offer ($). The user will then enter their contact information. The user may enter contact information [Name(s), Email(s), Phone(s)] for any roommates or co-tenants for review. This information is archived in the database for use in the contract preparation. As shown in FIG. 26(a). An educational link is provided for the users to learn more about the process.

3201 Lease Term: The leasing user must specify the lease requested. Lease terms available are month to month, more than 6 months, 6-12 months, more than 1 year. As shown in FIG. 26(b).

3202 The desired date of occupancy at which tenant wants to occupy the property is required. As well as the number of months the tenant expects to lease the property [FIG. 26(a)].

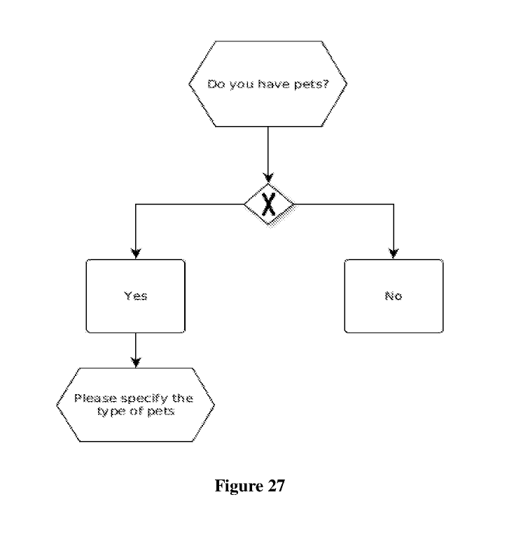

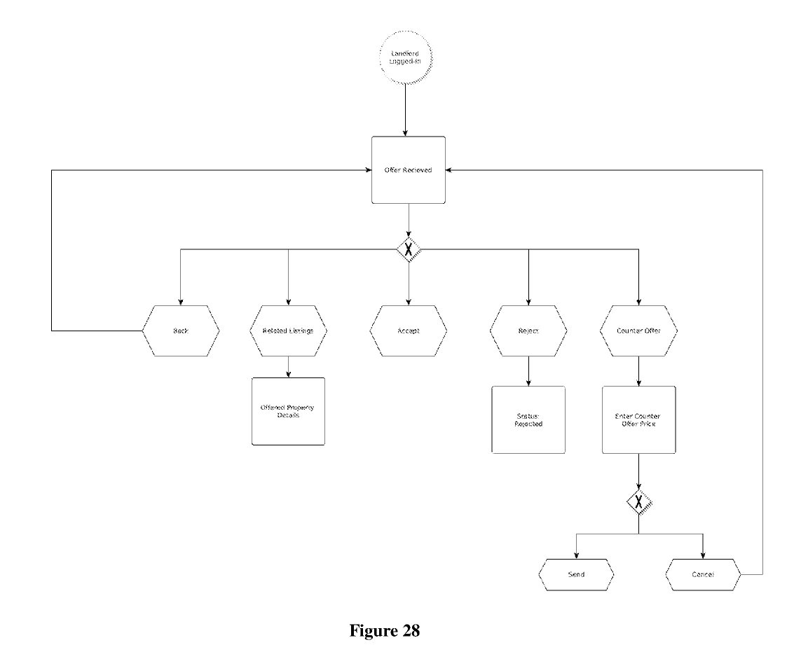

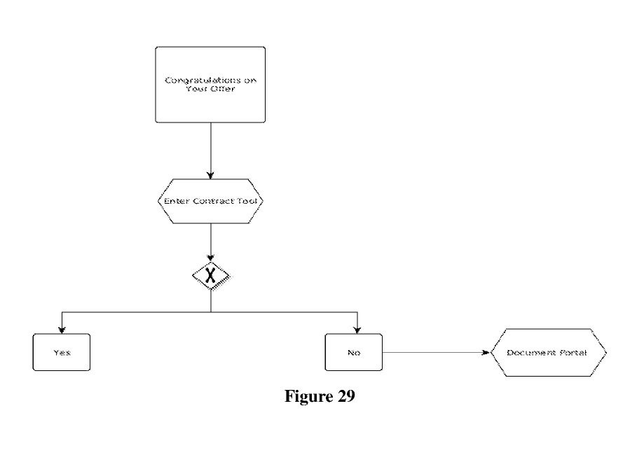

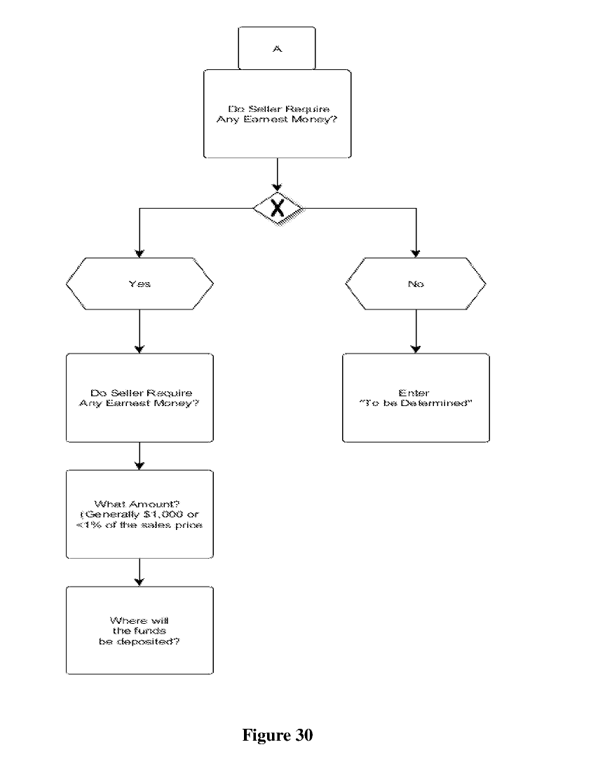

3203 Pets: The tenant may specify whether they own pets, and what types as shown in FIG. 27.

3204 The user must agree to our disclaimer clause to continue, noting that “the tentative offer is non-binding and unenforceable . . . ” As in FIG. 23 if the lessee agrees with the disclaimer, the offer will be sent to the landlord. If no agreement, the offer cannot be submitted. After submission, an email and site message will sent to the landlord regarding the offer.

3205: After the lessee makes their offer, the landlord will receive the offer and will need to take action to proceed. There are three possibilities as shown in FIG. 24. The landlord may accept the offer submitted, counter-offer the price, or reject the offer. If rejected, the lessee user may resubmit a new offer.

3206: If the landlord counters the offer, the lessee will receive a counter offer message and email. The lessee will not have the same options as the landlord had prior, as shown in FIG. 25. The lessee user may accept the offer submitted, counter-offer the price, or reject the offer. If rejected, the lessee user may resubmit a new offer. The negotiation may go back and forth between users as many times as necessary, and the options remain the same.

400 Contract Solutions—For Sale (Seller): Our platform provides the tools and guidance to help buyers and sellers seamlessly prepare contracts through signing. Buyers and sellers answer a few simple questions, and our platform completes the rest. As reference from FIG. 29, the selling user has the option to use our contract software by clicking on ‘Yes’ and if user clicks ‘No’ then it takes him to the document portal, where instructions, contracts and disclosures are available.

410 Seller Questionnaire: As the seller enters the contract tool the first step is the questionnaire for seller.

4101: A) Do you require any earnest money (See FIG. 30)? If ‘Yes’, what amount does the seller require? (Generally $1,000 or <1% of the sales price) and if Yes, Where will the funds be deposited?

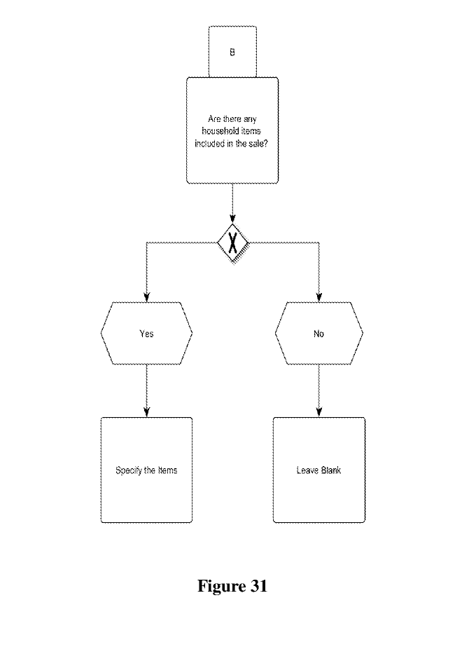

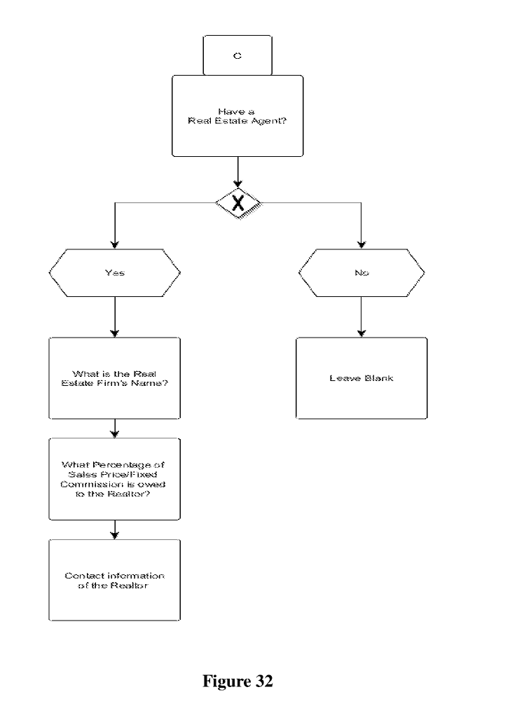

4102: B) Are there any household items included in the sale (ie: Refrigerator, Furniture, Range Oven, Dish-Washer, Microwave, TV Console, Living Room Sofa, Etc. etc)? As from FIG. 31 If answered ‘yes’, the seller should specify the items which die included and it no, leave it blank.

4103 C) Does seller have a Real Estate Agent? If yes, then the seller should include the Real Estate Firm's Name and Percentage of Sales Price/Fixed Commission owed to the Realtor, as well as the contact information of the Realtor [name and phone number] as in FIG. 32.

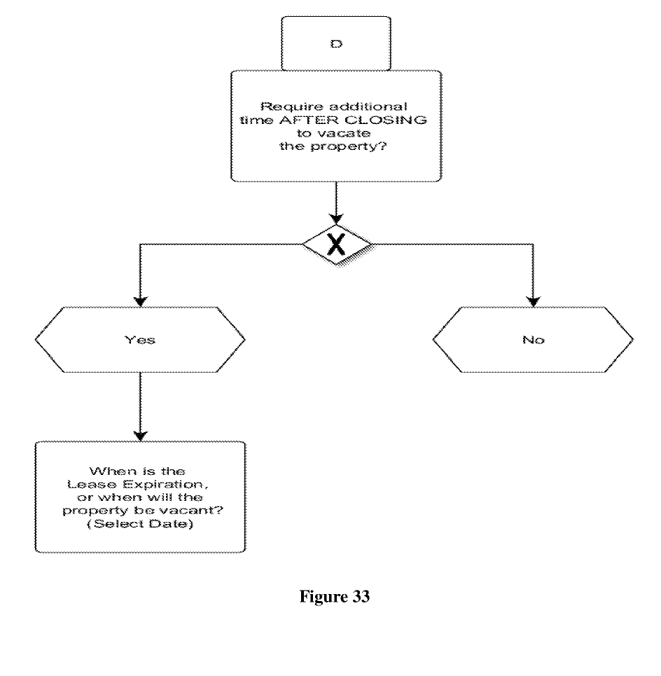

4104-D) As from FIG. 33, is the property of the seller currently occupied by a tenant (Leased)? Or the seller require additional time AFTER CLOSING to vacate the property? If yes, the seller must enter the expected date of possession via a drop-down calendar menu.

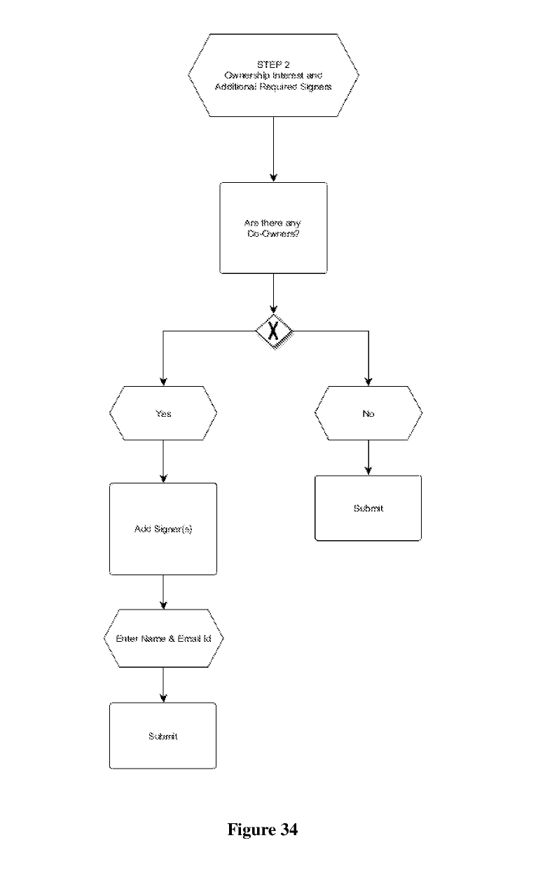

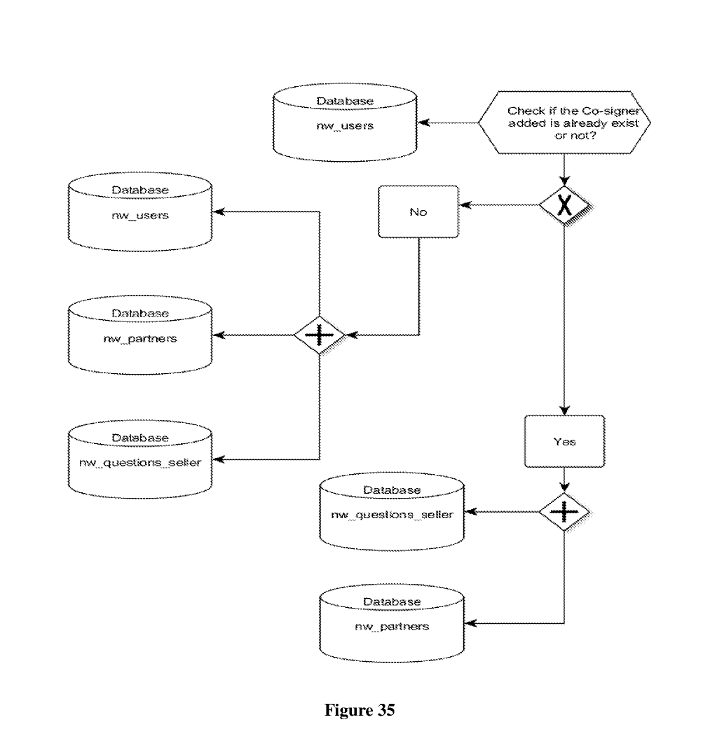

4105 Ownership interest and additional required signers: If the seller is married AND/OR if he own this property jointly (Are there any Co-Owners?) If answered is yes than seller must add his spouse or co-owner as a signer as illustrated in FIG. 34. If cosigner added is already exist or not as shown in FIG. 35. If no than user added to the database table having all the users. Also the activation link will be send to the co-signer added through the email.

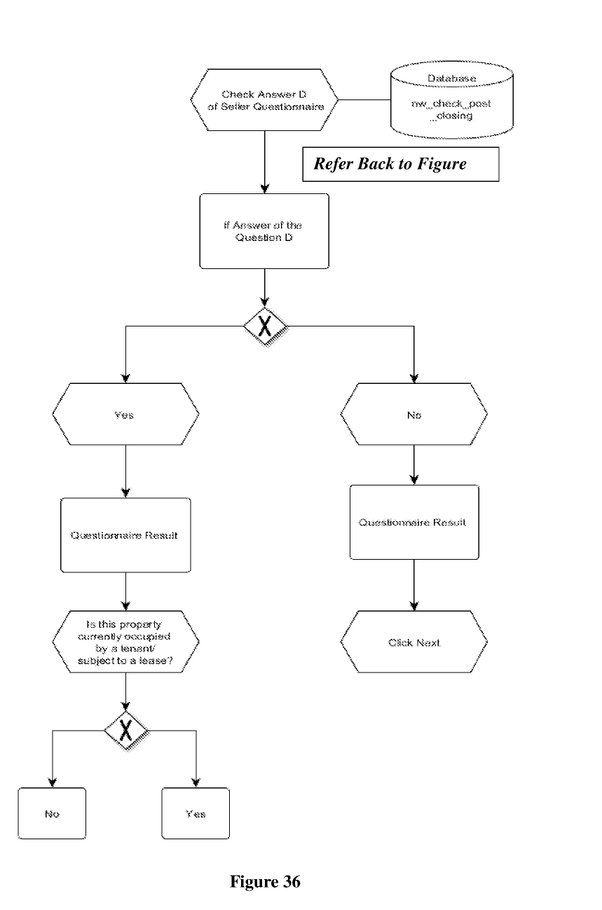

420 Lease or Post-closing Occupancy Contingency: as illustrated in FIG. 36 If the property is currently occupied by a tenant or seller needs time after closing to vacate property, our platform will include this as a stipulation [See Stipulation B] in the Purchase and Sale Agreement. If property is not subject to a lease, the contract tools will assist seller in preparing a (draft) post-closing occupancy agreement.

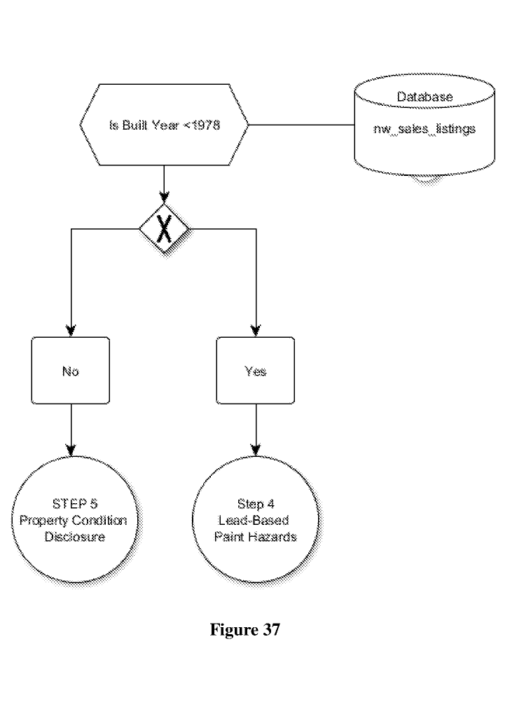

4201 Now the system will check the build year of the property (as provided by the listing user upon listing) if it was built on or after 1978, the system will bypass the Lead Based Paint Hazard Disclosure, otherwise the system will trigger this form for topic 450 below (as displayed in FIG. 37).

430 Post-Closing Occupancy Questionnaire: If the routing noted in 420 above requires the preparation of the post-closing occupancy agreement, the user must provide the following information.

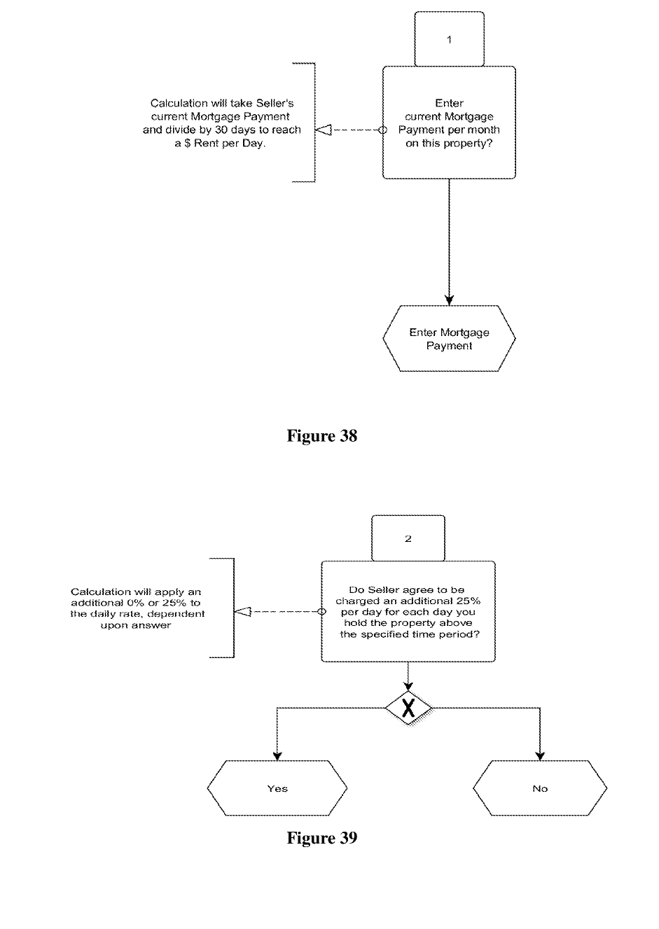

4301 What is current Mortgage Payment per month on this property? (In this calculation will take seller current Mortgage Payment and divide by 30 days to reach a $ Rent per Day). (FIG. 38)

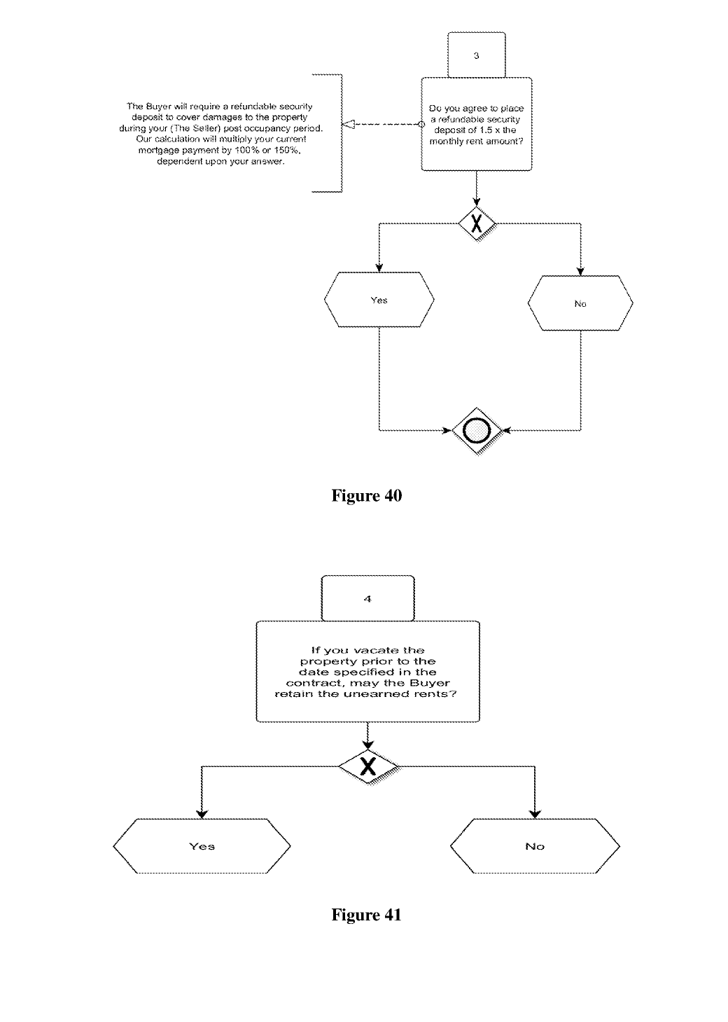

4302 Do you agree to be charged an additional 25% per day for each day you hold the property above the specified time period? (In this calculation will apply an additional 0% or 25% to the daily rate, dependent upon your answer.) (FIG. 39)

4303 Do you agree to place a refundable security deposit of 1.5× the monthly rent amount? The Buyer will require a refundable security deposit to cover damages to the property during your (The Seller) post occupancy period. Our calculation will multiply current mortgage payment by 100% or 150%, dependent upon your answer. (FIG. 40)

4304 If you vacate the property prior to the date specified in the contract, may the Buyer retain the unearned rents? (FIG. 41)

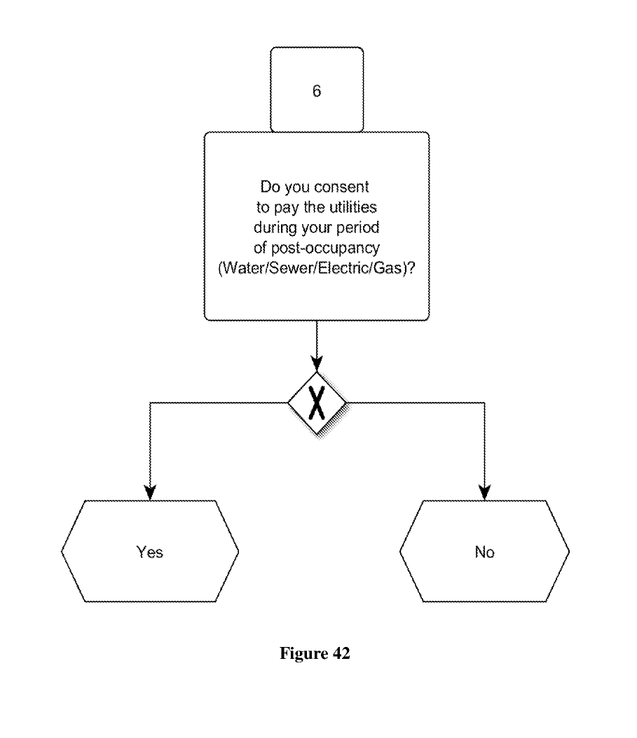

4305 Do you consent to pay the utilities during your period of post-occupancy (Water/Sewer/Electric/Gas)? (FIG. 42)

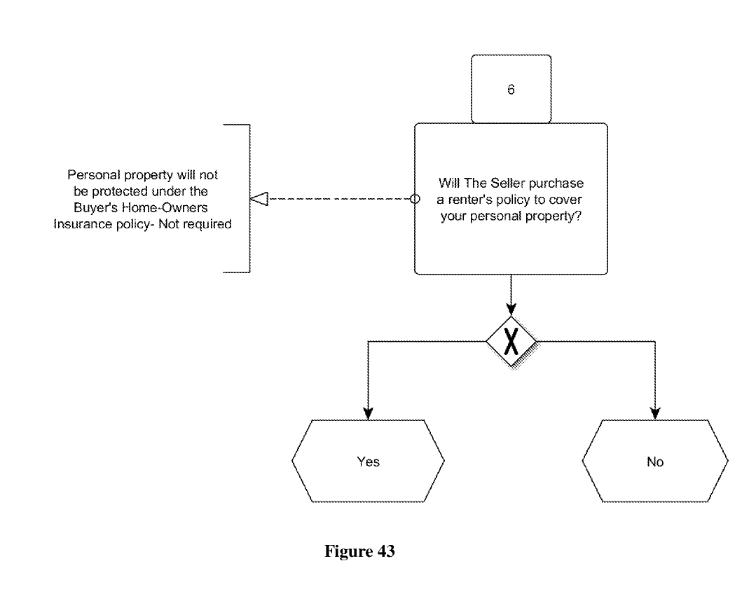

4306 Will the Seller purchase a renter's policy to cover your personal property? (FIG. 43)

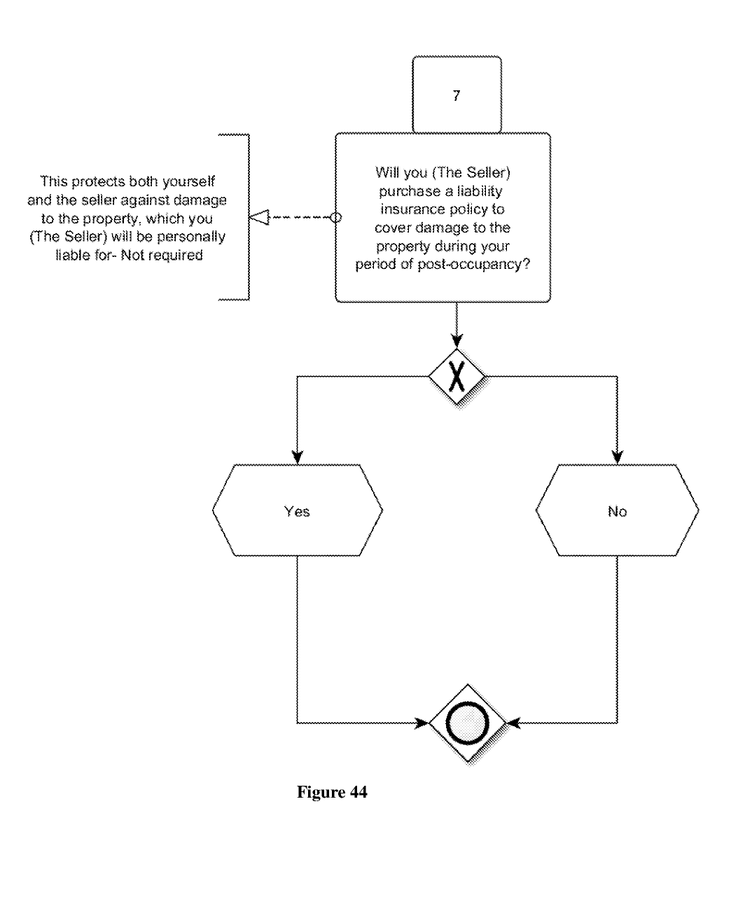

4307 Will the Seller purchase a liability insurance policy to cover damage to the property during your period of post-occupancy? (FIG. 44)

440 Post-Closing Occupancy Agreement review: Based on the answers provided, a draft is prepared of sellers Post-Closing Occupancy Agreement. This form serves as a short-term “Lease” effective after the sale of property.

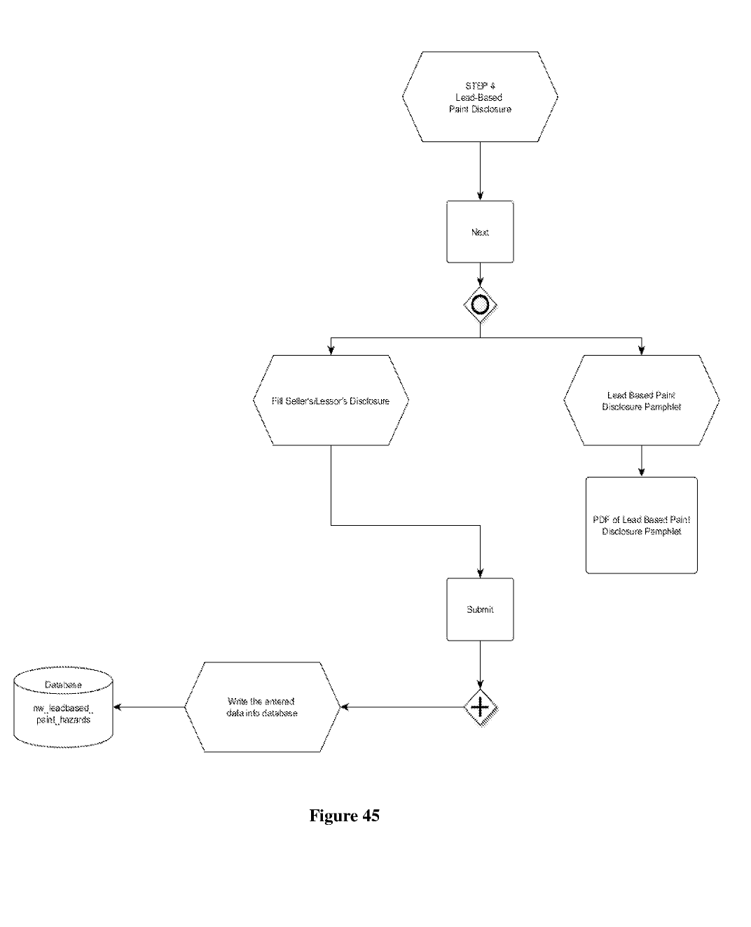

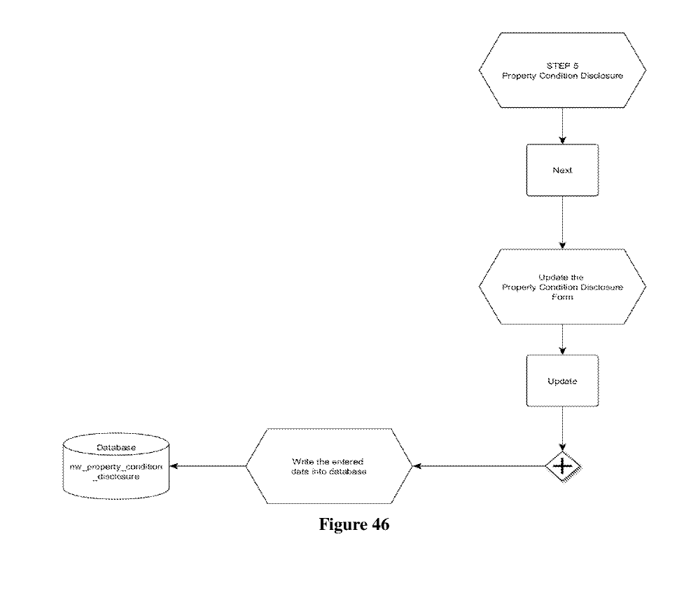

450 Lead-Based Paint Disclosure: As illustrated from FIG. 45, if the routing in 4201 above requires a Lead-Based Disclosure form, this form is added to the users document packet and the following notifications and questions must be answered.

4501 Seller's or Lessor's Disclosure:

a) Presence of lead-based paint and/or lead-based paint hazards:

b) Records and reports available to the seller: Seller should note they either have provided the purchaser with all available records and reports pertaining to lead-based paint and/or lead-based paint hazards, or the seller has no reports or records pertaining to lead-based paint and/or lead-based paint hazards. (FIG. 45)

460 Property Condition Disclosure: This form is built to allow the seller to fully disclose any defects or known issues on the property. The seller should complete this form and answer each question to the best of their knowledge. If an answer is an estimate, clearly label it as such. Explain any YES answers and describe the nature and extent of any defects or repairs. (FIG. 46)

470 Purchase and Sales Agreement (Draft):

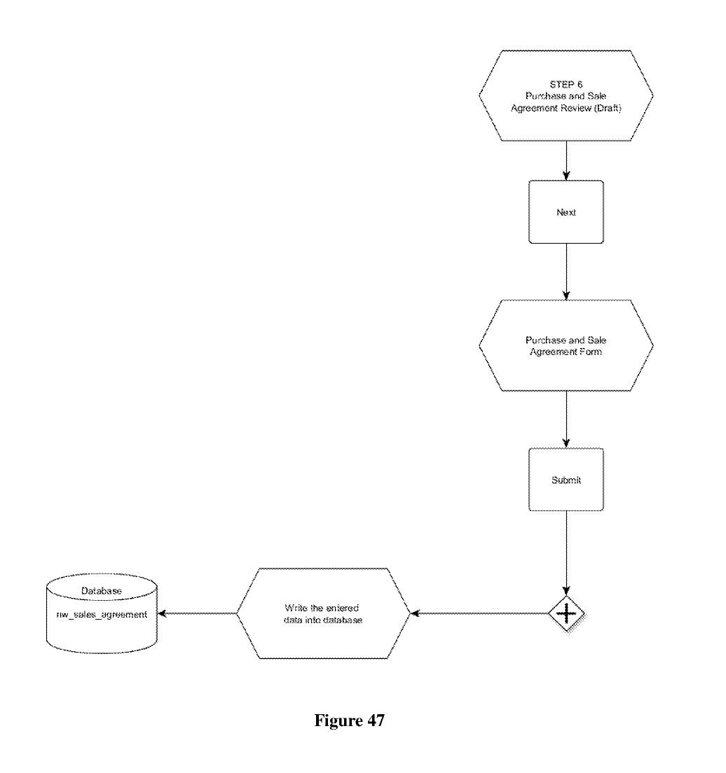

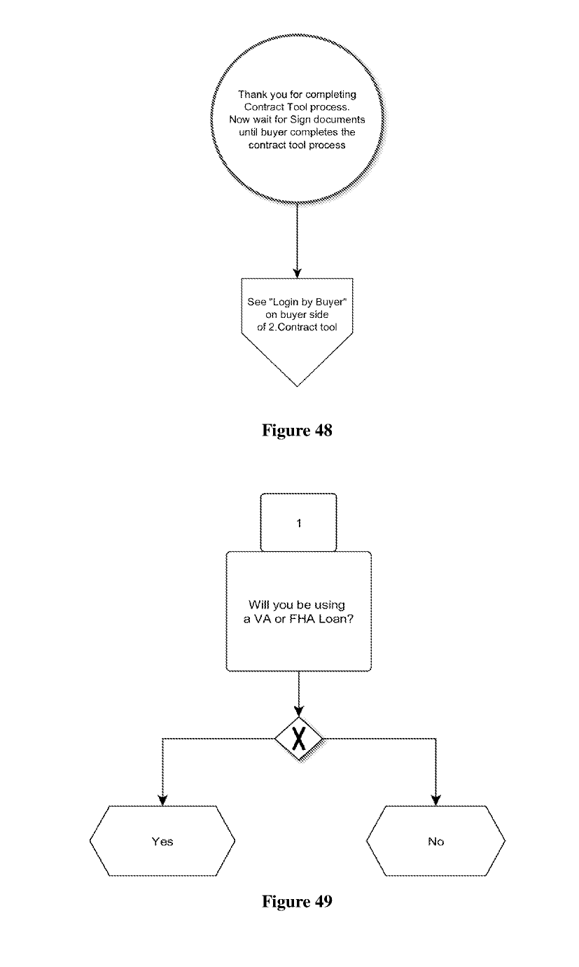

In this form, it is critical that seller will confirm & Update, if needed the Seller Name(s) To update—Navigate to “My Account”->“Edit Profile”->“Full (Legal) Name” Earnest Money Escrow Agent (Third Party Attorney, Broker, Title Company, etc.), and their understanding of the terms of the contract (FIG. 47). After completing this form the contract tool from the seller side is complete. Now the buyer will receive email and message to complete the contract tool as shown in FIG. 48.

500 Contract Solutions—For Sale (Buyer): After the seller completes their side of the contract tools, the buyer answers a few questions and reviews the documents.

510 Buyer Questionnaire:

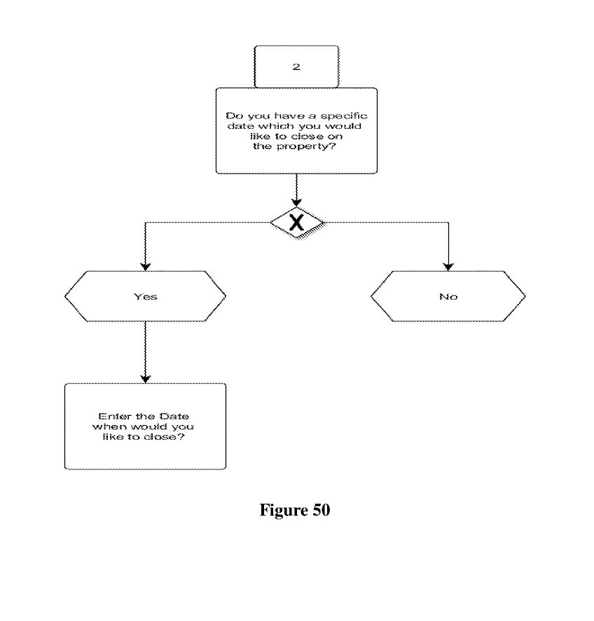

5101 Will you be using a VA or FHA Loan? If ‘yes’, a VA/FHA Loan addendum is added to the document packet. If ‘No’, this form is not provided. (FIG. 49)

5102 Do you have a specific date which you would like to close on the property? If “No”, the contract will state [current+30 days] as a tentative date and if “yes” buyer has to select the date at which he like to close the property. (FIG. 50)

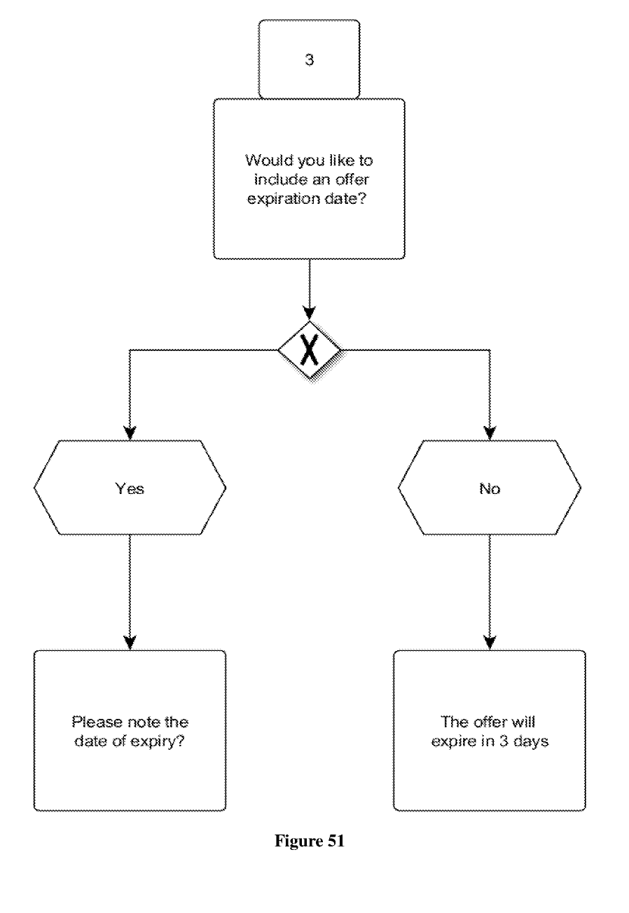

5103 Would you like to include an offer expiration date? If “No”, the offer expiration date will be set to expire in 3 days. If “yes” buyer has to select the date at which offer will expire. (FIG. 51)

520 Ownership interest and additional required signers: if buyer is married AND/OR if he own this property jointly (Are there any Co-Owners?) If the answer is yes than seller must add his spouse or co-owner as a signer as illustrated in FIG. 34. If the cosigner added is already exist or not as shown in FIG. 35. If no than user added to the database table having all the users. Also the activation link will be send to the co-signer added through the email.

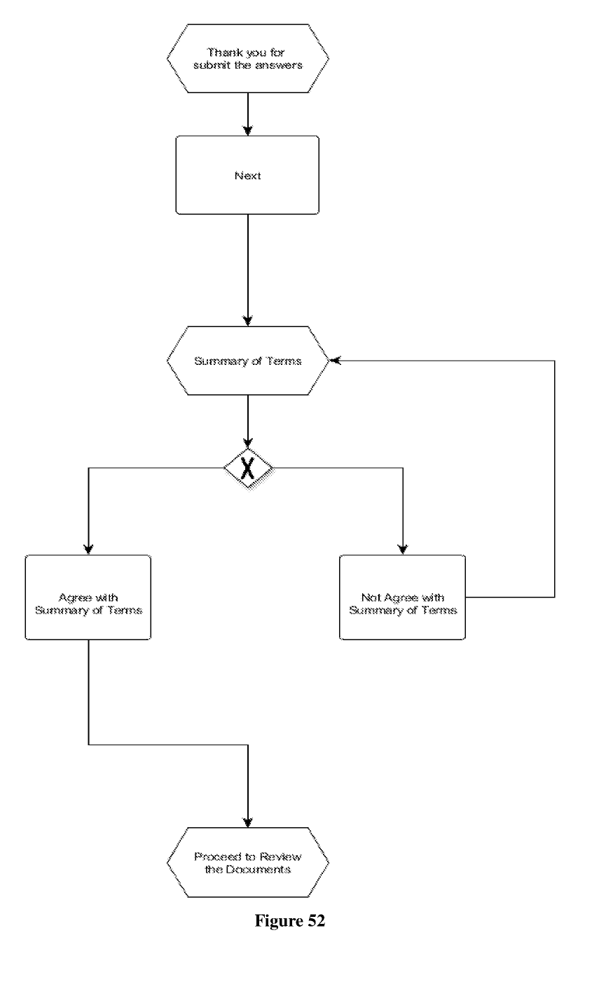

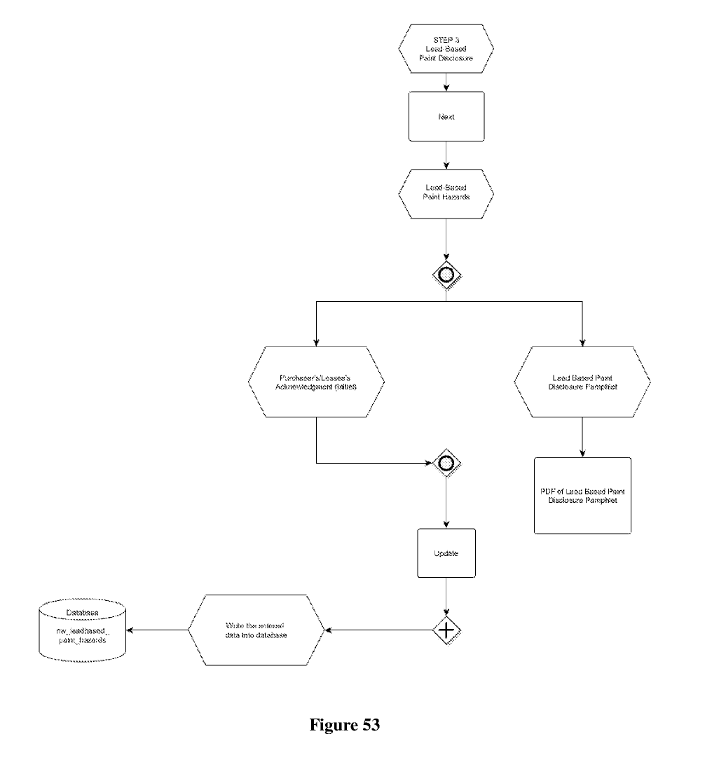

530 Summary of Terms: After adding the cosigner there is a summary of terms for the buyer having earnest money information, stipulations and all the terms of the seller. Buyer has to agree with terms if he want to continue the contract tool. (FIG. 52)

540 Advisory to Buyers and Sellers: Buyer must review this document for information to consider in their transaction.

550 Property Condition Disclaimer:

The Property Condition Disclaimer form is a required disclosure. The buyer must review the form in detail for known defects/issues in the property provided by the Seller. Known Defects on the property should be clearly disclosed. (As prepared by the seller)

560: Lead-Based Paint Hazards:

As illustrated in FIG. 53, if this form was triggered for the Seller in topic 4201, the system will display this form to the buyer for completion.

5601 Purchaser's/Lessee's Acknowledgment (initial): Seller/Lessor hereby provides the Buyer/Lessee with the EPA's Lead Based Paint Pamphlet Here: “Lead Based Paint Disclosure Pamphlet”.

5602 Buyer have read the EPA's “Lead Based Paint Disclosure Pamphlet”, or Purchaser has received copies of all information from the seller/lessor listed above.

5603 Purchaser has received a 10-day opportunity (or mutually agreed upon period) to conduct a risk assessment or inspection for the presence of lead-based paint and/or lead-based paint hazards, or

Waived the opportunity to conduct a risk assessment or inspection for the presence of lead-based paint and/or lead-based paint hazards.

570 VA/FHA Loan Addendum: As noted in 5101 above, If the Buyer answers yes in the question set for buyer, the following form is required if the buyer will be using a VA/FHA insured mortgage loan.

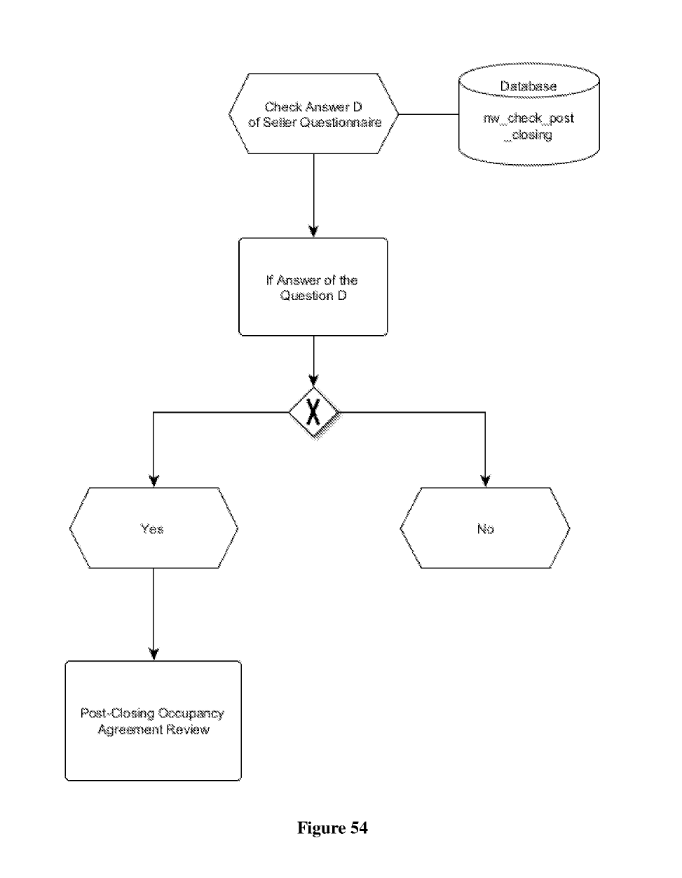

580 Post-closing Occupancy Agreement: If the seller required the post-closing occupancy form, the buyer must review this agreement with the conditions noted by the seller (See 420 above). (FIG. 54)

590 Purchase and Sale Agreement Review: In this form, it is critical that buyer confirm & Update, if needed Buyer Name(s), Earnest Money Escrow Agent, any designated closing dates and/or offer expiration buyer requested.

5901 Completion of Preparation: Next both the buyer(s) and seller(s) will proceed to sign the documents. [Skip to 800]

600 Contract Solutions—For Rent (Landlord): Our platform provides the tools and guidance to help tenants and landlords seamlessly prepare contracts through signing. Tenants and Landlords answer a few simple questions, and our platform completes the rest. As reference from FIG. 29, the landlord user has the option to use our contract software by clicking on ‘Yes’ and if user clicks ‘No’ then it takes him to the document portal, where instructions, contracts and disclosures are available.

610 Questions to Landlord:

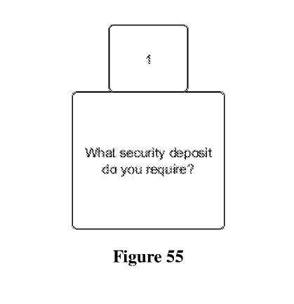

6101 What security deposit do you require? Some US States have set limits on the amounts of security deposit collected by landlords. For more information regarding this there is a link available. (FIG. 55)

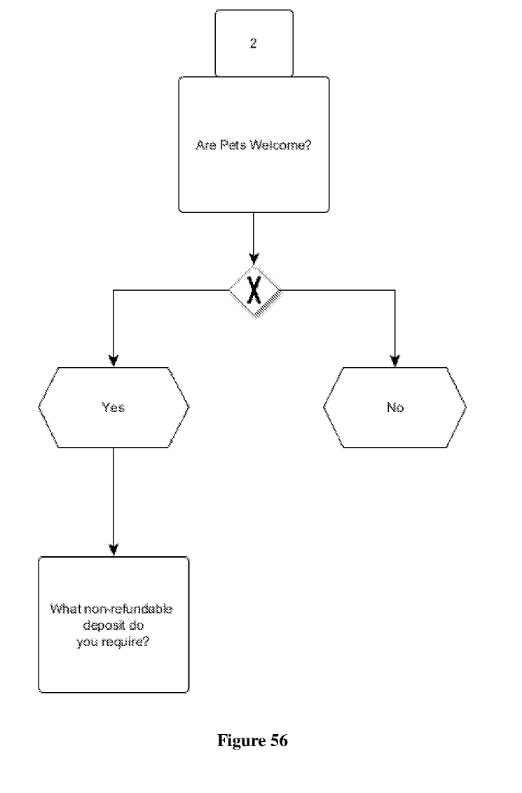

6102 Are Pets Welcome? If yes then what non-refundable pet deposit does the landlord require? (FIG. 56)

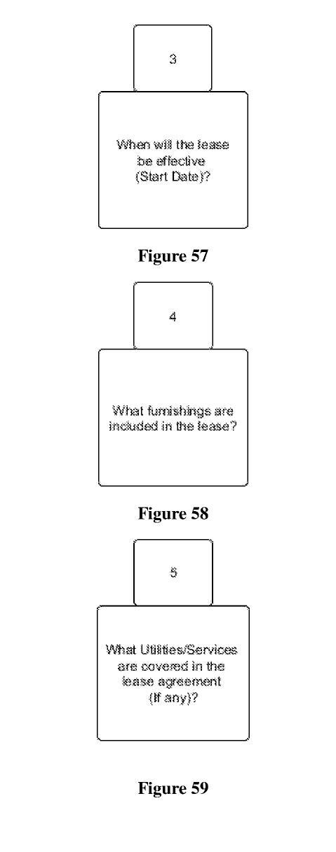

6103 When will the lease be effective (Start Date)? The landlord must specify the effective date of lease. (FIG. 57)

6104 What furnishings are included in the lease? (FIG. 58)

6105 What Utilities/Services are covered in the lease agreement (If any)? (FIG. 59)

6106 Will you require a Co-Signer on the Lease?

620 Ownership Interest and Additional Required Signers: Is the landlord is married AND/OR if he own this property jointly (Are there any Co-Owners)? If the answer is yes, the landlord is advised to add his spouse or co-owner as a signer as illustrated in FIG. 34. If cosigner added is already exist or not as shown in FIG. 35. If no than user added to the database table having all the users. Also the activation link will be send to the co-signer added through the email.

630 Lead-Based Paint Disclosure: As illustrated from FIG. 45, if the home is built before 1978 a Lead-Based Disclosure form is required. This form is systematically added to the user's document packet and the following notifications and questions must be answered:

6301 Landlord's Disclosure:

a) Presence of lead-based paint and/or lead-based paint hazards:

b) Records and reports available to the seller: Seller should note they either have provided the purchaser with all available records and reports pertaining to lead-based paint and/or lead-based paint hazards, or the seller has no reports or records pertaining to lead-based paint and/or lead-based paint hazards. (FIG. 45)

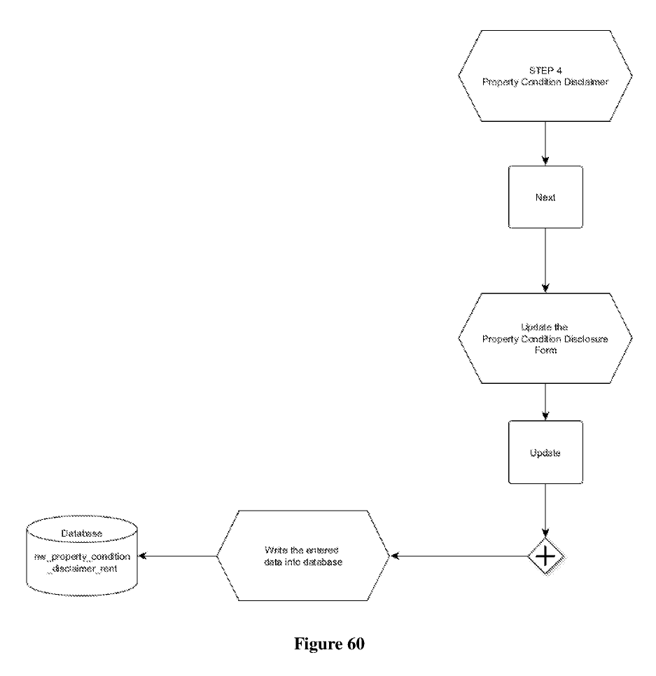

640 Property Condition Disclosure: The Property Condition Disclaimer form is a required disclosure. The buyer must review the form in detail for known defects/issues in the property provided by the Seller. Known Defects on the property should be clearly disclosed. (As prepared by the landlord) (FIG. 60)

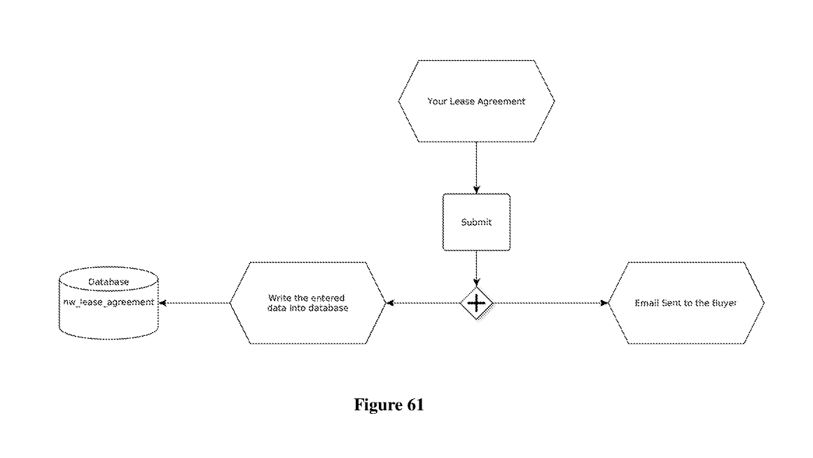

650 Lease Agreement (Draft): Landlord must review the draft Lease Agreement. In this form, it is critical that landlord confirm & Update, if needed the Landlord Name(s) and Contact Information, Rental $ Price, Security and Pet Deposits (If Applicable), (FIG. 61) After submitting the review of the draft lease agreement, the landlord preparation step is performed. The tenant will next complete their review and add any additional signers to the lease & documents.

700 Contract Solutions—For Rent (Tenant): Now the Tenant will complete the contract tool process.

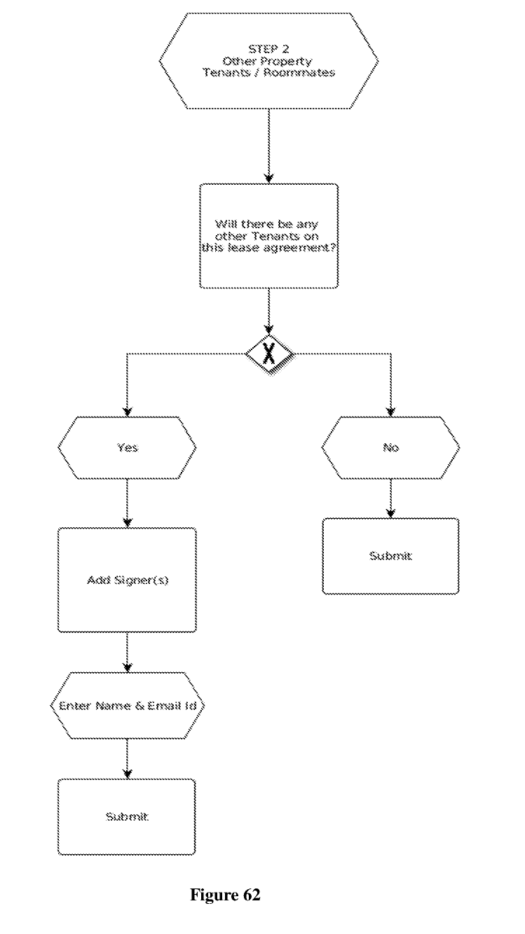

710 Notice to Tenant: The tenant is notified of important items and about the process they are about to perform. Example: [“In the next few steps, Tenant will review the lease agreement and disclosures, which are based on the terms defined in the accepted offer. Before the tenant begin, it is important that he confirm & Update Tenant Legal Name, Your Current Mailing Address, Other Contact Information. To update—Navigate to “My Account”->“Edit Profile”->“Full (Legal) Name”.] (FIG. 62)

720 Other Tenants/Roommates: This relates to whether any other Tenants will be added to the lease agreement. If Yes, the tenant should add his associated tenant(s) as signer(s) to the contract. If the cosigner is already registered, they are selected by the user FIG. 35. If the cosigner is not already registered, the user is added to the database, and an activation link will be send to the co-signer via email.

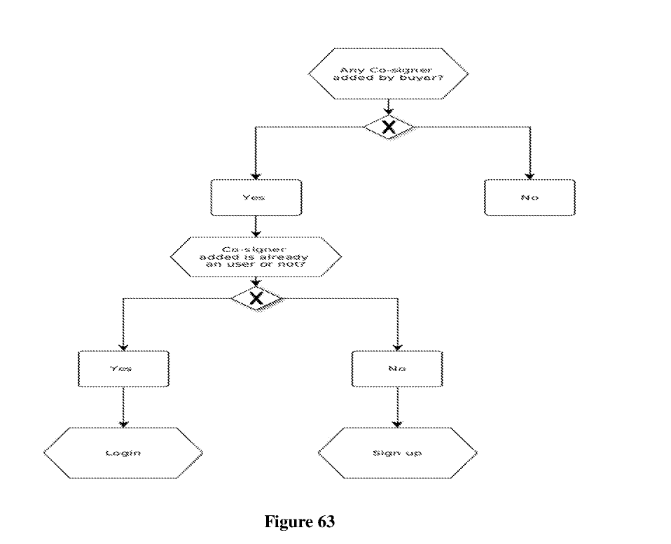

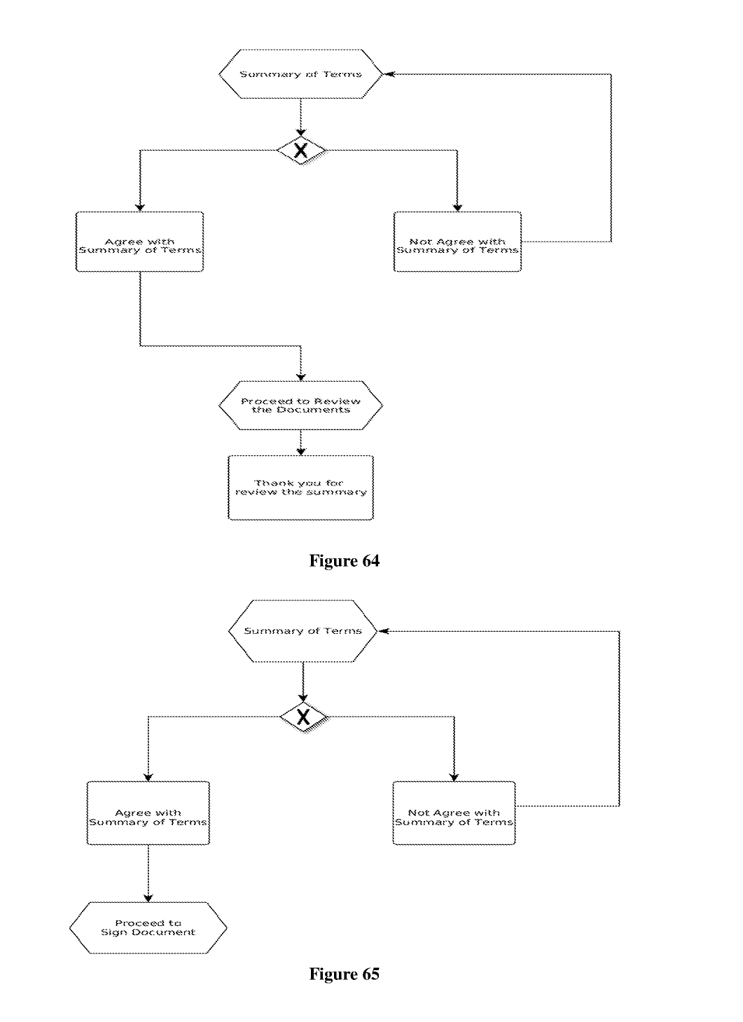

730 Summary of Terms: After adding any co-signer(s), there is a Summary of Terms displayed, showing the property information, lease term, begin and end date, contingencies and other information. The tenant must attest to reading and agreeing with the terms before proceeding. (FIG. 63)

740: Lead-Based Paint Hazards: (If applicable from 630 above)—As illustrated in FIG. 53, if the home is built before 1978 a Lead-Based Disclosure form is required. This form is systematically added to the user's document packet and the following notifications and questions must be answered:

7401 Purchaser's/Lessee's Acknowledgment (initial): Seller/Lessor hereby provides the Buyer/Lessee with the EPA's Lead Based Paint Pamphlet Here: “Lead Based Paint Disclosure Pamphlet”.

7402 Lessee(s) have read the EPA's “Lead Based Paint Disclosure Pamphlet”, or Lessee(s) has received copies of all information from the seller/lessor listed above.

7403 Lessee(s) has received a 10-day opportunity (or mutually agreed upon period) to conduct a risk assessment or inspection for the presence of lead-based paint and/or lead-based paint hazards, or

Waived the opportunity to conduct a risk assessment or inspection for the presence of lead-based paint and/or lead-based paint hazards. (FIG. 45)

750 Property Condition Disclosure: The Property Condition Disclaimer form is a required disclosure. The buyer must review the form in detail for known defects/issues in the property provided by the Seller. Known Defects on the property should be clearly disclosed (As prepared by the landlord). (FIG. 60)

760 Lease agreement: The tenants must review the Lease Agreement. In this form, it is critical that tenant confirm & Update, if needed the Tenant Name(s) and Contact Information, Rental $ Price, Security and Pet Deposits (If Applicable). (FIG. 61)

770 Completion of Preparation: At this point, the tenant has completed their preparation process. Next, the tenant(s) & landlord(s) will sign the documents. [Skip to 1000]

800 Sign Documents (Sale): The order of signing are all buyers, then sellers after. If the buyer added any co-signer(s), the co-signer's signature is mandatory. The co-signer(s) must be registered in the site, and will sign with their own unique login. Important Note: The signature process is set to each individual. Each party must have their own account and will follow the same process individually. (FIG. 64)

810 Summary of Terms: Before signing any documents, the buyer(s) will review a summary of the agreement. This is an added security step, and they must agree to the terms to proceed. (FIG. 65)

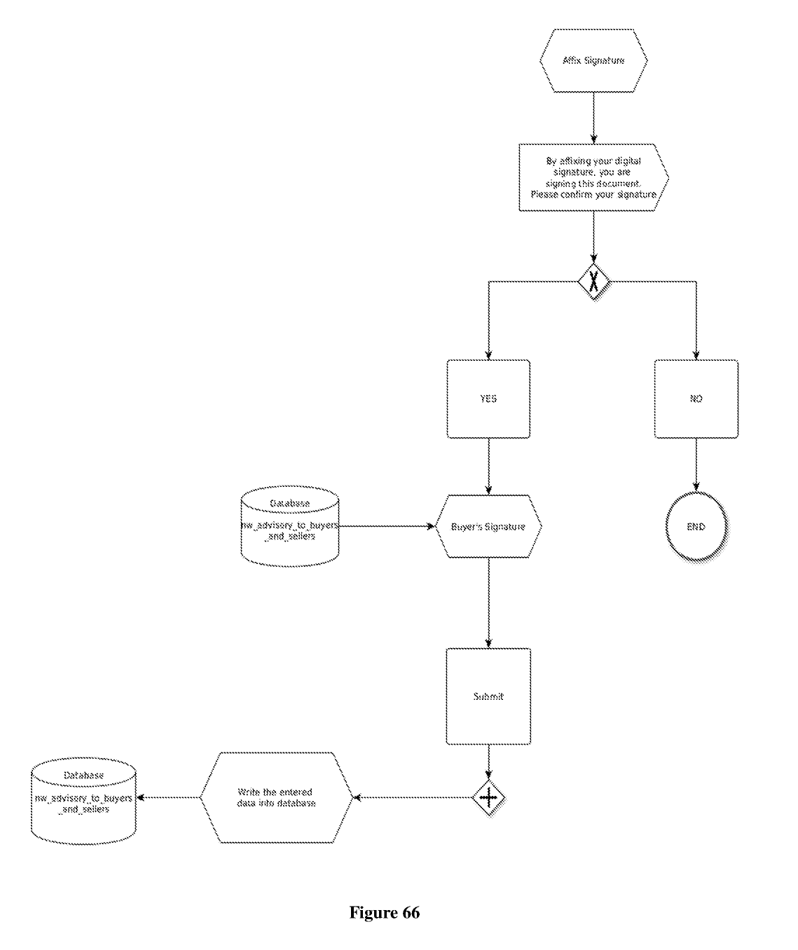

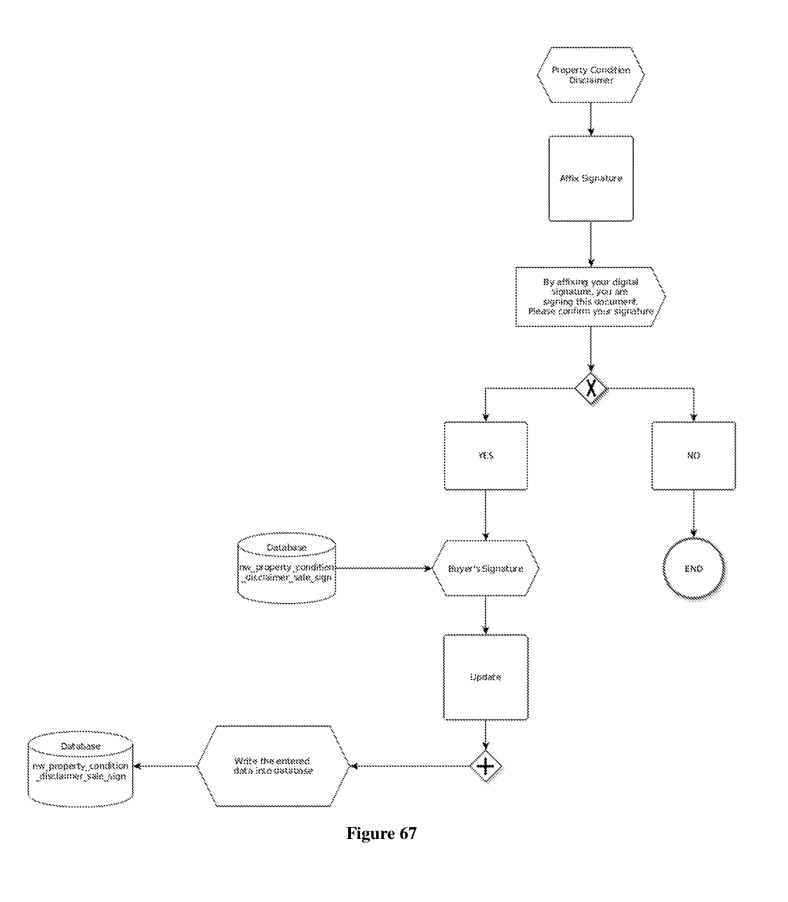

820 Advisory to Buyers and Sellers: Next, the buyer(s) will sign the advisory to buyer and seller by clicking “Affix Signature”. The signature will affixed as it was stored in database previously at the time of registration. Illustrated in FIG. 66.

830 Property Condition Disclosure: After Advisory to buyer and seller there is the Property Condition Disclaimer to sign by the buyer(s). (FIG. 67)

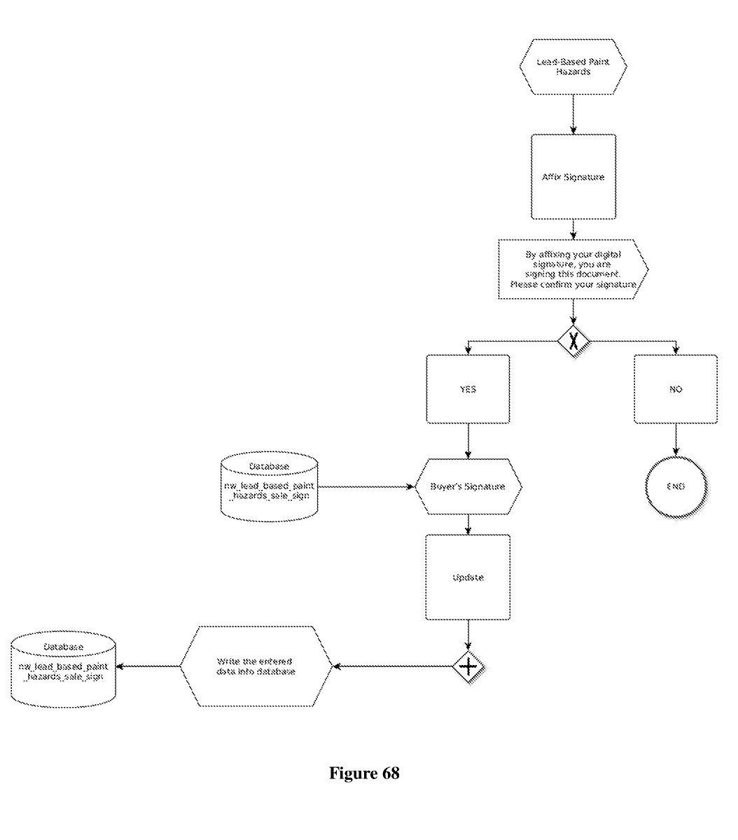

840 Lead-Based Paint Hazards: If the property was built before 1978 [as noted in 420 above] this form is required to be signed. (FIG. 68)

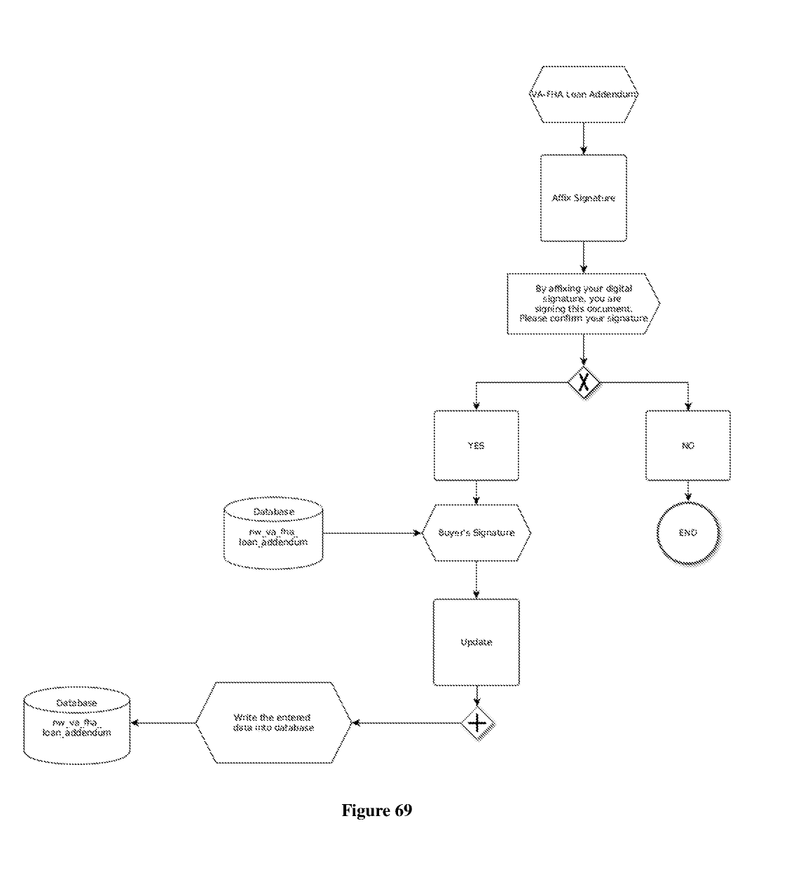

850 VA-FHA Loan Addendum: If applicable (per 5101 above), this form is required for signing. (FIG. 69)

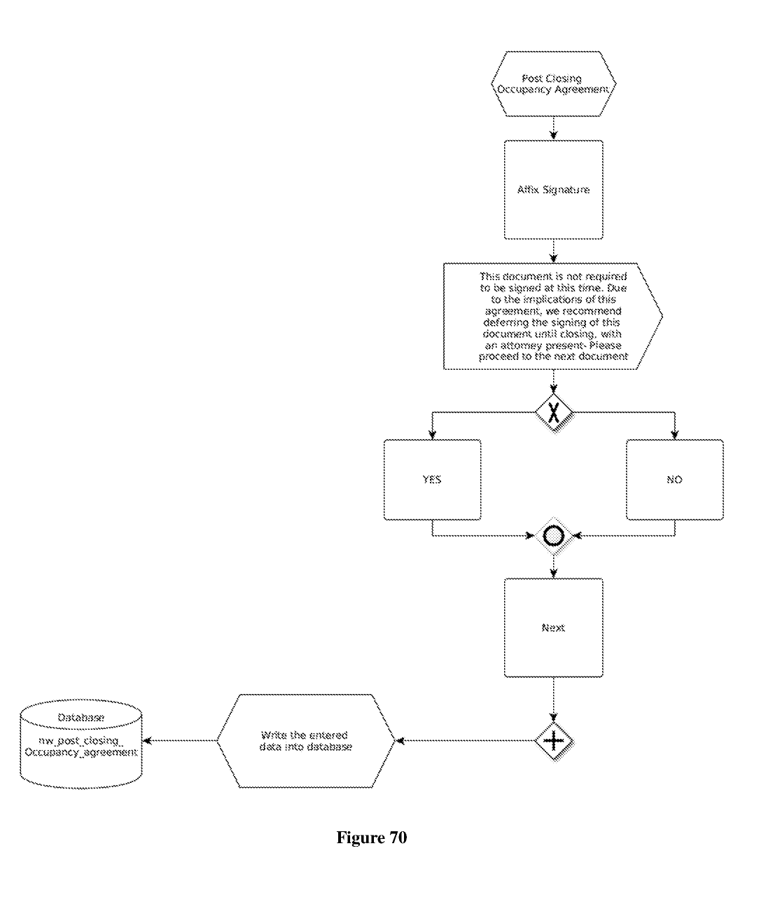

860 Post Closing Occupancy Agreement: Neither party will sign this form, but it will be displayed and noted to both parties—if selected as necessary by the seller (per section 420 above). (FIG. 70)

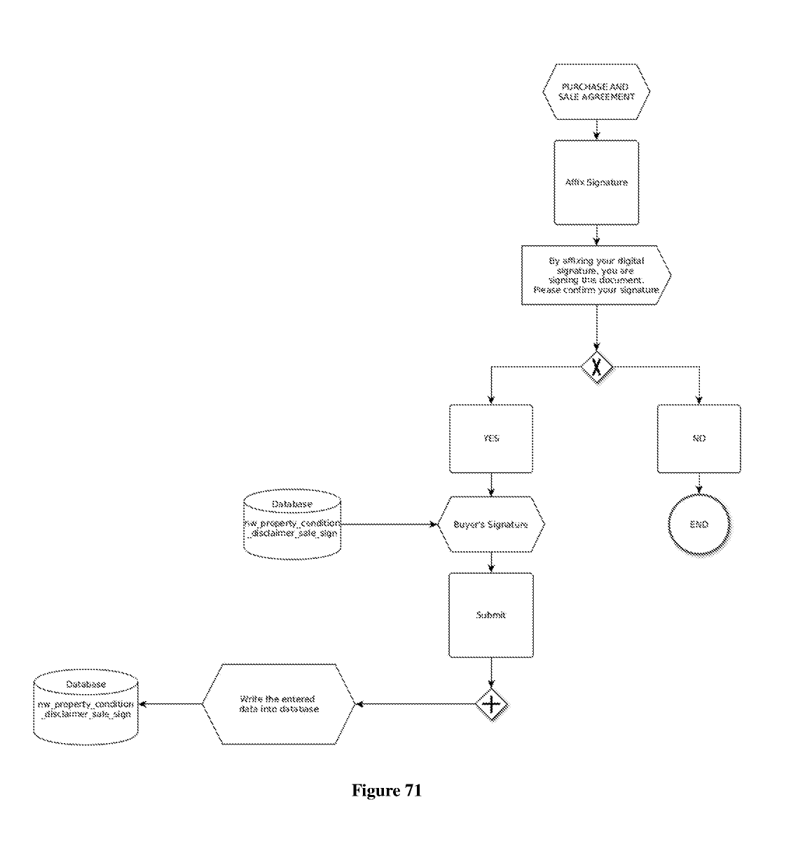

870 Purchase and Sales Agreement: Next, the buyer(s) sign the Purchase and Sales Agreement. (FIG. 71)

880 Seller(s) Signatures: Seller(s) follow the same process as the buyer(s) and proceed to sign the documents (Repeat the steps from 800-870)

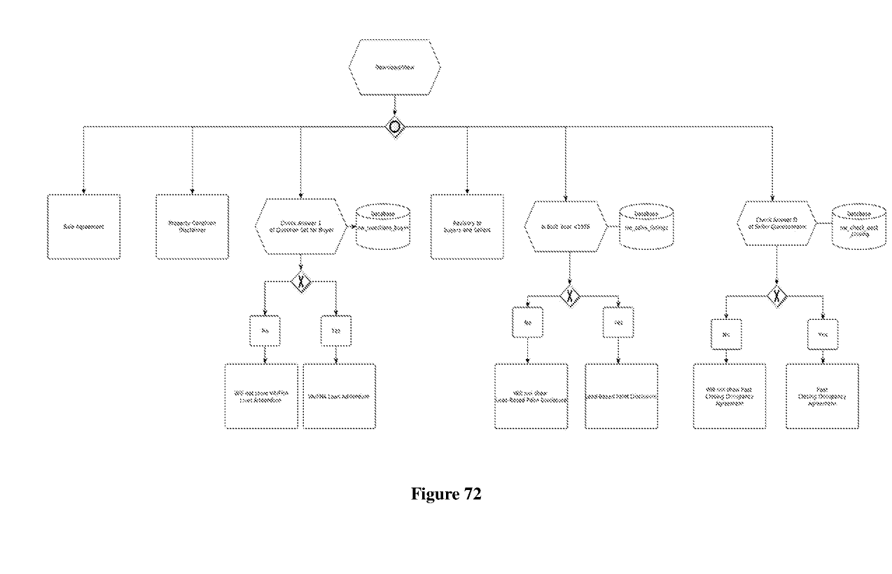

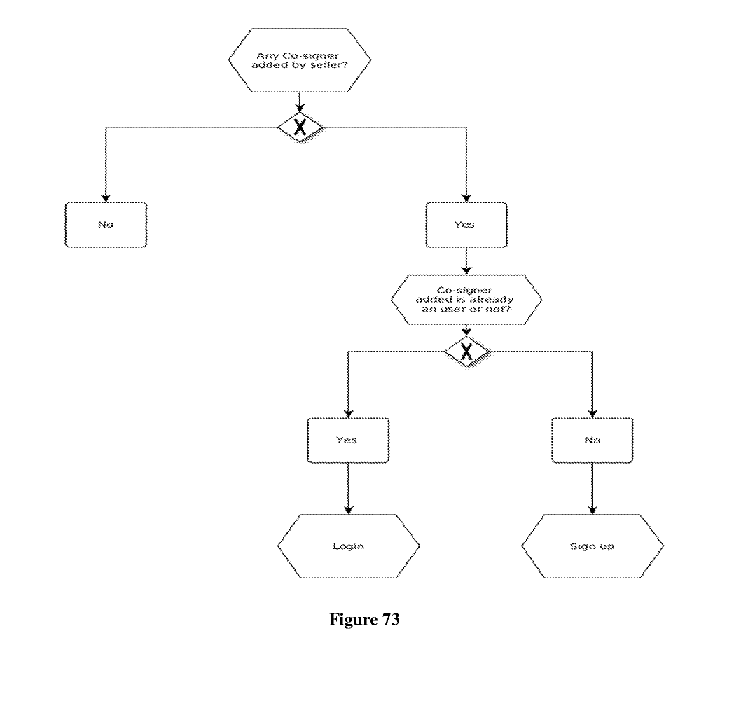

900 Purchase Documents (Sale): After signing the documents, the primary seller will purchase all the documents, through our secure payment gateway. Once the seller purchases the documents, the buyer and seller will be able to download/view all the executed agreements and forms in PDF. (As shown in FIG. 72)

1000 Sign Documents (Rent): The order of signing are all tenant(s), then landlord(s) after. If the tenant added any co-signer(s), the co-signer's signature is mandatory. The co-signer(s) must be registered in the site, and will sign with their own unique login. Important Note: The signature process is set to each individual. Each party must have their own account and will follow the same process individually. (FIG. 64)

1010 Summary of Terms: Before signing any documents, the tenant(s) will review a summary of the agreement. This is an added security step, and they must agree to the terms to proceed. (FIG. 65)

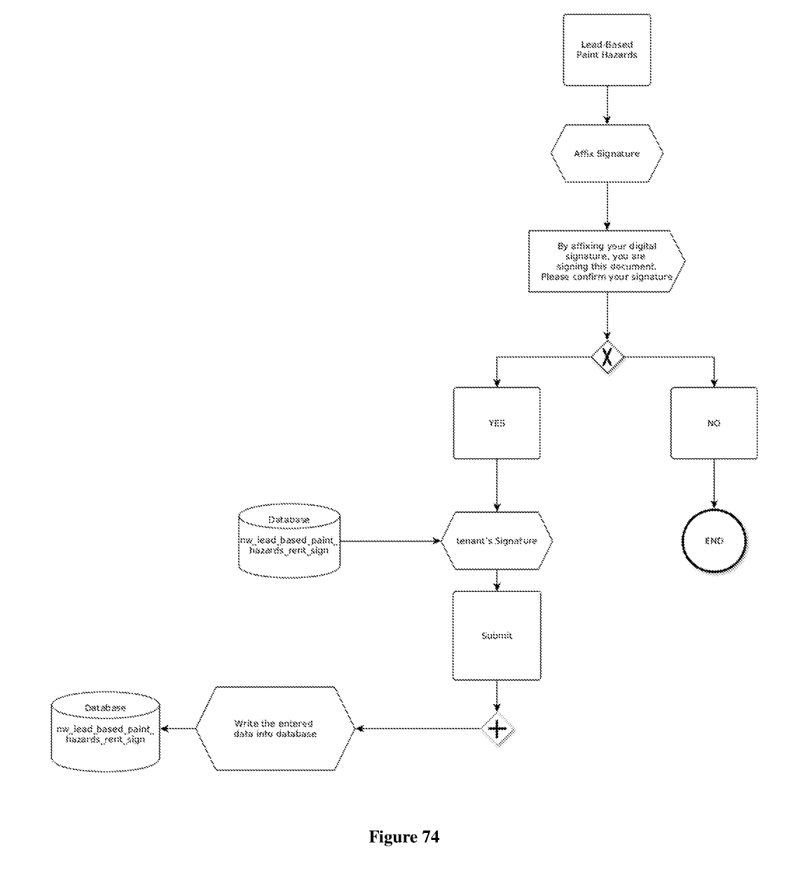

1020 Lead-Based Paint Hazards: If the properly was built before 1978 [as noted in 630 above] this form is required to be signed. (FIG. 74)

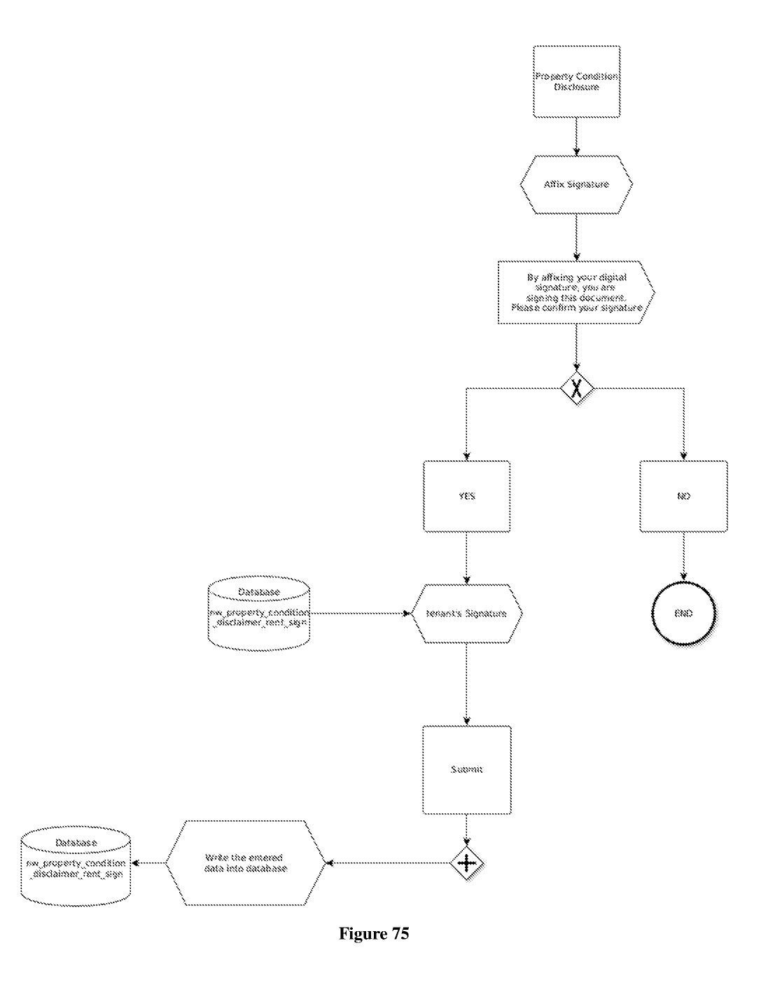

1030 Property Condition Disclosure: The Property Condition Disclosure is then signed by the tenant(s). (FIG. 75)

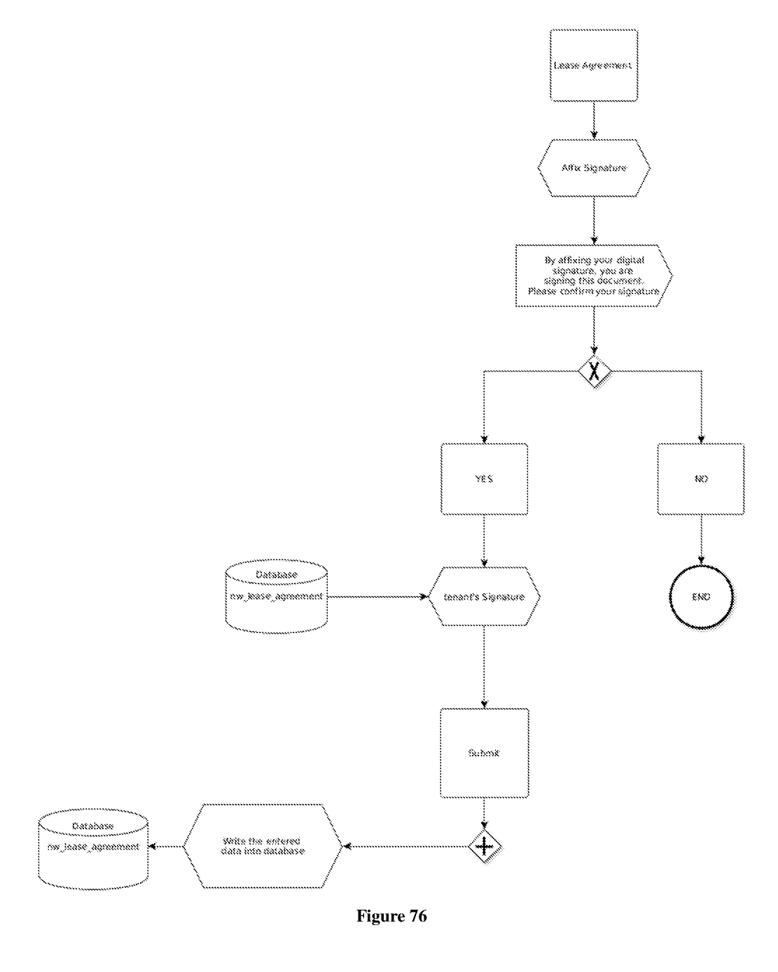

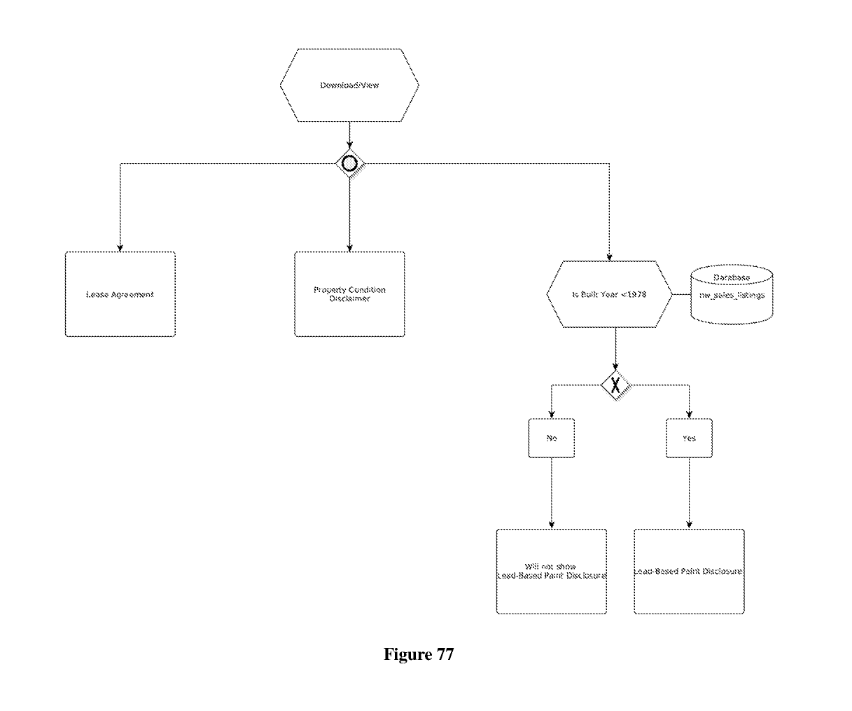

1040 Lease Agreement: Lastly, the Lease agreement is then signed. (FIG. 76)

1050 Landlord(s) Signatures: Landlord(s) follow the same process as the tenant(s) and proceed to sign the documents (Repeat the steps from 1000-1040)

1100 Purchase Documents (Rent): After signing the documents, the primary seller will purchase all the documents, through our secure payment gateway. Once the seller purchases the documents, the buyer and seller will be able to download/view all the executed agreements and forms in PDF. (As shown in FIG. 77)

### Definitions

None Deemed Necessary.

### CONCLUSION

The disclosed embodiments are illustrative, not restrictive. While specific configurations of the method and system have been described, it is understood that the present invention can be applied to a wide variety of Real Estate Applications. There are many alternative ways of implementing the invention.

What is claimed is:

1) A web-based system which embodies real estate solutions, comprising of:
a user registration process, which collects and stores information for each user in a database;
and
a login process, which securely controls access to user information with password protection and email verification;
and
a property listing function which allows registered users to create a property listing, which captures detailed property information and stores that information in a database;
and
a Property Search Platform which allows users to search for listed properties, retrieved from stored database information;
and
an electronic communication channel from one user to another, whereby a user may directly contact another, and the communication is captured in a database;
and
a scheduling function whereby a user may detail times of availability, which other users may view this availability and schedule appointments from available selections, and data is captured;
and
a Method of allowing a user to submit offer information to another user electronically and store the data in a database;
and
a method, whereby a user may Reject, Counter or Accept the terms of submitted offers and store the data in a database;
and
a contract preparation method, which captures and stores further data from user inputs, regarding negotiated property transactions and communications;
and
a method, which optimizes work-flows and triggers necessary documents and processes based on the information captured, stored and retrieved from the database;
and
a document review method, whereby at least one user from each of two parties of a contract (Buyer/Seller OR Landlord/Tenant) reviews the draft agreements, based on the contract preparation method, data captured from users entered and retrieved from the database, and displayed to the appropriate parties to the contracts;
and
a method of capturing E-Signatures using a unique and secure single channel signature flow, whereby each party to a contract securely signs only their signature field;
and
a method to accept payment for services;
and
a document storage and retrieval method, which allows users to download and print completed contracts.

2) A method of Engaging, Negotiating, Collecting Data, Optimizing Work-Flows, Preparing, Reviewing, E-Signing, Payment Processing, and Storing Legal Agreements and Disclosures, comprising of:
A Make an Offer function, allowing a user to submit offer information to another user electronically and store the data in a database;
and
a Negotiation function, linked to the submitted offers, to reject, counter, or accept offer details from another user, capture the original and amended data in a database;
and
a Contract Preparation process, which uses data captured from users, property listings, and the agreed upon offer terms to prepare documents, as necessary from a variability controlled work-flow, which optimizes the documents and forms necessary to each individual offer transaction;
and
a document review process, whereby at least one user from both sides of the contract (Buyer/Seller OR Landlord/Tenant) review the documents prepared using the contract preparation process for each offer transaction;
and
a linked e-Signature process, where each user has a unique login and signature flow to each offer transaction;
and
a document storage and access process, whereby users may download and print the executed contracts, specific to each offer transaction.

3) The method of claim 2, further comprising of an electronic function of submitting an offer to purchase, comprising of:
A secure registration/login requirement to control logical access;
and
a defined electronic form, which displays necessary offer information, including (but not limited to) an offer price, Offer contingencies, which if not met may void the agreement, A document upload function allowing a user to electronically provide pertinent documentation regarding their current lending qualification status and bank documents, Closing Cost Assistance Requested in the form of either a percentage of the purchase price, or a fixed $ amount, and User agreement controls, notating the user's agreement to liability disclaimers;
and
an electronic submission function of submitting the information to the database and communicating the offer to the recipient user, consisting of a Form Control which, upon electronically selecting Confirms the submission, Creates a new record in the database complete with the new information, and Contacts the recipient user of the offer details and how to proceed to the negotiation process.

4) The method of claim 2, further comprising of an electronic communication function, allowing users to communicate direct messaging or email, comprising of:
Secure login access;
and
Unique access to secure messages. These messages are directly communicated from one user to another, without the necessity of external systems and email servers;
and
Automated email notification;
and
Database storage of information and communication records.

5) The method of claim 2, further comprising of an electronic negotiation work-flow, where two users negotiate terms of the purchase agreement, consisting of:
A form control which, upon electronically selecting, Accepts the submitted terms by the offering user, Confirms the submission of acceptance, Updates the offer record in the database complete with the new information, Contacts the recipient user of the offer details and how to proceed to the negotiation process, and Launches a new form to display work-flow continuation options;
and
A form control which, upon electronically selecting, rejects the submitted terms by the offering user, Confirms the submission of rejection, Updates the offer record in the database complete with the new information, Contacts the recipient user of the offer details and rejection of offer;
and
A form control which, upon electronically selecting, opens a sub-form to counter-offer the offer terms submitted by the offering user, Confirms the submission of counter-offer, Updates the offer record in the database complete with the new information, and Contacts the recipient user of the offer details and how to proceed to the negotiation process.

6) The method of claim 2, further comprising of an opt-out option, whereby the user may deny the use of the document & contract preparation work-flow, consisting of:
A form to display pertinent information of the document & contract preparation work-flow;
and
a link and agreement to terms and conditions;
and
a form control allowing the user to electronically continue by accepting the terms and conditions, or exit the process work-flow, while maintaining all database information collected.

7) The method of claim 2, further comprising of a logical work-flow for preparing documents and contracts with variability controls, consisting of:
Logical IF Statements, which review database information and submission details for logical arguments (Example: IF 1=Yes, Then return “Proceed”, If Not, return “void”);
and
Pre-defined logical work-flows, which create a systematic flow of all necessary processes, consisting of Logical IF Statements, which review database information and submission details for logical arguments (Example: IF 1=Yes, Then return “Proceed”, If Not, return “void”), Pre-defined Logical Arguments (Triggers), which optimize the necessary forms, unique to each listing id, offer id, and transaction, and Pre-Defined forms & files, which provide the complete document and contract for work-flow integration;
and
a series of processes and questions designed specific to the needs of the buyer/tenant party(s) to the contracts;
and
a series of processes and questions designed specific to the needs of the seller/landlord party(s) to the contracts.

8) The method of claim 2, further comprising of a function allowing the primary parties to the contract to include additional parties & signers of the contracts, comprising of:
Unique identification, requiring each party to become a registered user;
and
identification verification and email activation;
and
a work-flow process, whereby the primary parties to the contract are able to add additional signers to the work-flow and contracts, at their discretion by entering the name and email address, then submitting the information;
and
a system function which create a new record in the user tables, an automated email requesting the recipient user/additional signer to complete their registration, and a linking of the two user accounts, to allow for future contract partnering.

9) The method of claim 2, further comprising of a document preparation process, which supports the creation of all the necessary documents in a real estate contract and is guided by the defined and optimized work-flows, consisting of:
Clarifying and qualifying questions directed to both the selling and buying users, of which the answers are submitted and stored in the database;
and
Database queries, which retrieve necessary information from stored data and apply this data to the electronic forms in integrated interface fields;
and
A complete list of defined real estate contracts and required disclosure forms displayed individually, in sequence, with integrated data fields displayed electronically, which are updated per optimized work-flows by retrieving and displaying queried data into the respective form fields, as necessary, via automated database queries;
and
A form preparation process, whereby users will review defined electronic forms and automatically populated fields for accuracy, consisting of Read-Only text data and integrated data fields for review, Input fields for manual override, Form display interfaces, allowing users to analyze the documents in print format, and Form controls, which upon electronically selecting by the users, Confirms the submission of data accuracy, Updates the form records in the database complete with the new information, and Proceeds to the next process in the work-flow;
and
a secure document storage facility, whereby the users may view their unofficial prepared contracts for accuracy electronically.

10) The method of claim 2, further comprising of a document review process, whereby all parties of the contract review the documents prepared using the contract preparation process for each offer transaction, consisting of:
The relevant (triggered) draft forms and integrated data fields, which were prepared per the optimized work-flow processes in the contract preparation process, comprising of System queries, data retrieval and display from the database which completes each pre-defined form and displays this data in the appropriate fields;
and
A form review process, whereby the users party to the contract review draft forms and automatically populated fields for accuracy, consisting of Read-Only fields for review, Form display interfaces, allowing users to analyze the documents in print format, Form controls, which upon electronically selecting by the users, Confirms the submission of the document review, Updates the form records in the database, noting completion, and upon review by all parties to the contract, unlocks the E-Signature Process work-flows;
and
a secure document storage facility, whereby the users may view their unofficial reviewed contracts electronically.

11) The method of claim 2, further comprising of an Electronic Signature Process, utilizing a customized signature function which integrates electronic signatures directly and securely to the prepared and reviewed contracts process work-flow, consisting of:
A secure signature work-flow, requiring each party to the contract to be registered and activated within the system. Additional parties to the contracts (signers) must be added by the primary party(s) during the work-flow processes, An electronic signature created upon registration and stored in the database, and Agreement to the E-Sign Act Disclosure;
and
a process which generates a query on the date, time, name, electronic signature, and IP Address, and captures this data into the database upon signing;
and
a security workflow, which only captures and records the e-signatures off the registered and logged in user into the database;
and
Form controls, which upon electronically selecting by the users Confirms the submission of the electronic signature, Updates the form records in the database, noting completion, Direct the user to the next document for signing;
and
system controls which prevent the Selling/Landlord parties to the contract from signing, until the Buyers/Tenants have complete their signature processes.

12) The method of claim 2, further comprising of an electronic signature processing system, which records the e-signatures for each user, on each document, for the completion of the executed agreements prepared through the optimized contract preparation and review processes, for each intersection of offer id and listing id, consisting of:
Data queries which retrieve defined data to complete the signature application, on each user, consisting of Name, E-Signature, Date, Time, and IP Address;
and
a data capture and storage process, which submits the captured data into the database, upon request and confirmation by the signing user;
and
a requirement that the user confirm their intention to sign the contracts, with a secondary confirmation sub-form.

13) The method of claim 2, further comprising of a service payment processing facility, whereby the user provides payment for the contract solutions, consisting of:
A system retrieval of the unique user login information, and the listing id & offer id intersect associated with each contract;
and
a payment gateway, which captures payments for the solutions and executed contracts;
and
a systematic recording of the payment record, which unlocks the contracts for PDF view and download.

14) The method of claim 2, further comprising of a PDF conversion process for all executed forms, consisting of:
Secure user account access for the user to access their executed contracts;
and
a document storage facility, integrated with the documents prepared, reviewed and signed, whereby the user is able to access their executed agreements;
and
a system process, which converts the executed agreements into PDF for viewing and downloading.

15) The method of claim 2, further comprising of a communication system, consisting of:
Automatic notifications to the parties of the contract, sent at defined milestones per the process work-flows, which contain instructions or updates;
and
integration to the contract preparation and electronic signature work-flows, triggering automatic notification.
